(19) United States
(12) Patent Application Publication
(10) Pub. No.: US 2024/0163833 A1
(43) Pub. Date: May 16, 2024

(54) NON-TERRESTRIAL NETWORK (NTN) SEARCH SPACE OPTIMIZATION

(71) Applicant: QUALCOMM Incorporated, San Diego, CA (US)

(72) Inventors: Junsheng HAN, Los Altos Hills, CA (US); Kannan MUTHURAMAN, Mission Viejo, CA (US); Francesco GRILLI, La Jolla, CA (US); Carl HARDIN, Encinitas, CA (US); Venkatraman RAJAGOPALAN, San Diego, CA (US)

(21) Appl. No.: 18/478,130

(22) Filed: Sep. 29, 2023

Related U.S. Application Data
(60) Provisional application No. 63/383,846, filed on Nov. 15, 2022.

(51) Int. Cl. H04W 64/00; H04W 16/28; H04W 76/50

(52) U.S. Cl. CPC H04W 64/00; H04W 16/28; H04W 76/50; H04W 84/06

(57) ABSTRACT

Disclosed are techniques for wireless communication. In an aspect, a wireless communications device detects a trigger to communicate via non-terrestrial network (NTN) connectivity, determines whether one or more obstructions are estimated to be blocking a subset of NTN space vehicles of a set of NTN space vehicles expected to be in view of the wireless communications device at a current location of the wireless communications device, and transmits, in response to a determination that the one or more obstructions are estimated to be blocking the subset of NTN space vehicles, at least one message towards at least one NTN space vehicle of the set of NTN space vehicles other than the subset of NTN space vehicles.

### CROSS-REFERENCE TO RELATED APPLICATIONS

The present application for patent claims the benefit of U.S. Provisional Application No. 63/383,846, entitled “NON-TERRESTRIAL NETWORK (NTN) SEARCH SPACE OPTIMIZATION,” filed Nov. 15, 2022, assigned to the assignee hereof, and expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a wireless communications device includes detecting a trigger to communicate via non-terrestrial network (NTN) connectivity; determining whether one or more obstructions are estimated to be blocking a subset of NTN space vehicles of a set of NTN space vehicles expected to be in view of the wireless communications device at a current location of the wireless communications device; and transmitting, in response to a determination that the one or more obstructions are estimated to be blocking the subset of NTN space vehicles, at least one message towards at least one NTN space vehicle of the set of NTN space vehicles other than the subset of NTN space vehicles.

In an aspect, a method of wireless communication performed by a wireless communications device includes detecting a trigger to communicate via non-terrestrial network (NTN) connectivity; determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and transmitting at least one message towards at least one NTN space vehicle of the one or more NTN space vehicles during at least one alignment opportunity of the one or more alignment opportunities.

In an aspect, a wireless communications device includes one or more memories; one or more transceivers; and one or more processors communicatively coupled to the one or more memories and the one or more transceivers, the one or more processors, either alone or in combination, configured to: detect a trigger to communicate via non-terrestrial network (NTN) connectivity; determine whether one or more obstructions are estimated to be blocking a subset of NTN space vehicles of a set of NTN space vehicles expected to be in view of the wireless communications device at a current location of the wireless communications device; and transmit, via the one or more transceivers, in response to a determination that the one or more obstructions are estimated to be blocking the subset of NTN space vehicles, at least one message towards at least one NTN space vehicle of the set of NTN space vehicles other than the subset of NTN space vehicles.

In an aspect, a wireless communications device includes one or more memories; one or more transceivers; and one or more processors communicatively coupled to the one or more memories and the one or more transceivers, the one or more processors, either alone or in combination, configured to: detect a trigger to communicate via non-terrestrial network (NTN) connectivity; determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and transmit, via the one or more transceivers, at least one message towards at least one NTN space vehicle of the one or more NTN space vehicles during at least one alignment opportunity of the one or more alignment opportunities.

In an aspect, a wireless communications device includes means for detecting a trigger to communicate via non-terrestrial network (NTN) connectivity; means for determining whether one or more obstructions are estimated to be blocking a subset of NTN space vehicles of a set of NTN space vehicles expected to be in view of the wireless communications device at a current location of the wireless communications device; and means for transmitting, in response to a determination that the one or more obstructions are estimated to be blocking the subset of NTN space vehicles, at least one message towards at least one NTN space vehicle of the set of NTN space vehicles other than the subset of NTN space vehicles.

In an aspect, a wireless communications device includes means for detecting a trigger to communicate via non-terrestrial network (NTN) connectivity; means for determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and means for transmitting at least one message towards at least one NTN space vehicle of the one or more NTN space vehicles during at least one alignment opportunity of the one or more alignment opportunities.

In an aspect, a non-transitory computer-readable medium stores computer-executable instructions that, when executed by a wireless communications device, cause the wireless communications device to: detect a trigger to communicate via non-terrestrial network (NTN) connectivity; determine whether one or more obstructions are estimated to be blocking a subset of NTN space vehicles of a set of NTN space vehicles expected to be in view of the wireless communications device at a current location of the wireless communications device; and transmit, in response to a determination that the one or more obstructions are estimated to be blocking the subset of NTN space vehicles, at least one message towards at least one NTN space vehicle of the set of NTN space vehicles other than the subset of NTN space vehicles.

In an aspect, a non-transitory computer-readable medium stores computer-executable instructions that, when executed by a wireless communications device, cause the wireless communications device to: detect a trigger to communicate via non-terrestrial network (NTN) connectivity; determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and transmit at least one message towards at least one NTN space vehicle of the one or more NTN space vehicles during at least one alignment opportunity of the one or more alignment opportunities.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating a non-terrestrial network (NTN) communication scenario in which the user is orienting a mobile device towards a space vehicle, according to aspects of the disclosure.

FIG. 5 illustrates two example sky plots of the trajectories of Iridium NEXT satellites as viewed from San Diego, California, according to aspects of the disclosure.

FIG. 6 is a diagram illustrating an example scenario in which a set of space vehicles is blocked from the view of a mobile device by a mountainside, according to aspects of the disclosure.

FIG. 7 is a diagram illustrating an example scenario in which the camera of a mobile device is used to determine whether there is a line-of-sight (LOS) path to a space vehicle, according to aspects of the disclosure.

FIGS. 8 and 9 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to non-terrestrial network (NTN) communication. Some aspects more specifically relate to NTN search space optimizations. In some examples, a wireless communications device may utilize three-dimensional (3D) maps to determine how to remove NTN space vehicles from the search space based on nearby environmental features. In some examples, the wireless communications device may use global navigation satellite system (GNSS) radio frequency (RF) measurements to determine an optimal time for the user to start the pointing process.

Particular aspects of the subject matter described in this disclosure can be implemented to realize one or more of the following potential advantages. In some examples, by utilizing 3D maps to remove NTN space vehicles from the search space, the described techniques can be used to reduce latency (and therefore reduce power consumption) and improve reliability of NTN connectivity by reducing the size of the search space of NTN space vehicles to unobstructed NTN space vehicles.

In some examples, by using GNSS RF measurements to determine an optimal time for the user to start the pointing process, the described techniques can be used to reduce time to acquire NTN connectivity and therefore improve power consumption in NTN connectivity scenarios. Additional advantages include ease of use, in that it does not require manual adjustment to the device orientation, which a user may not be capable of performing.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

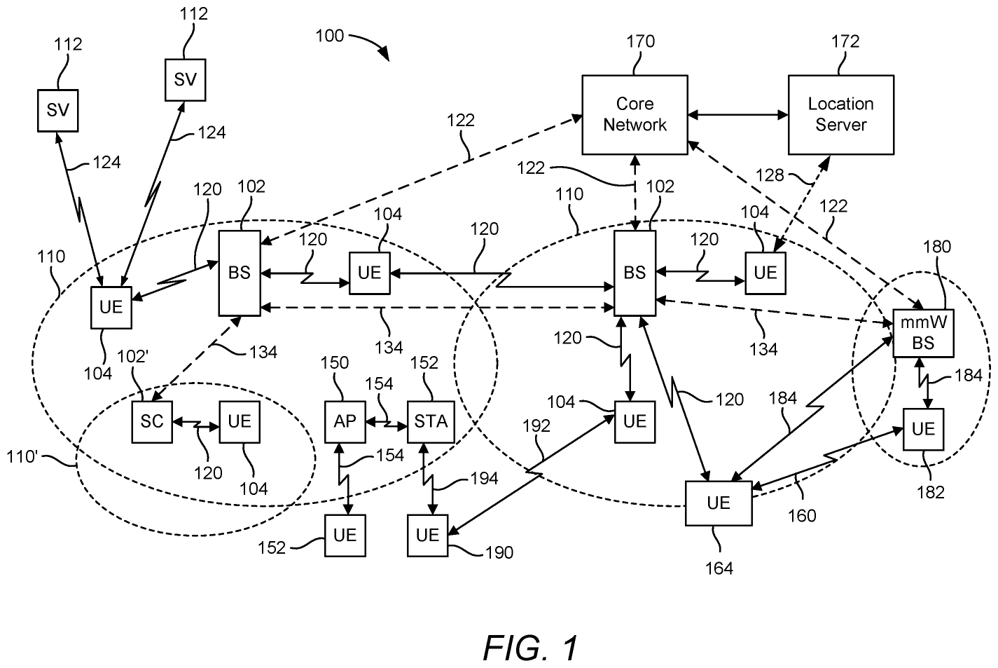

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

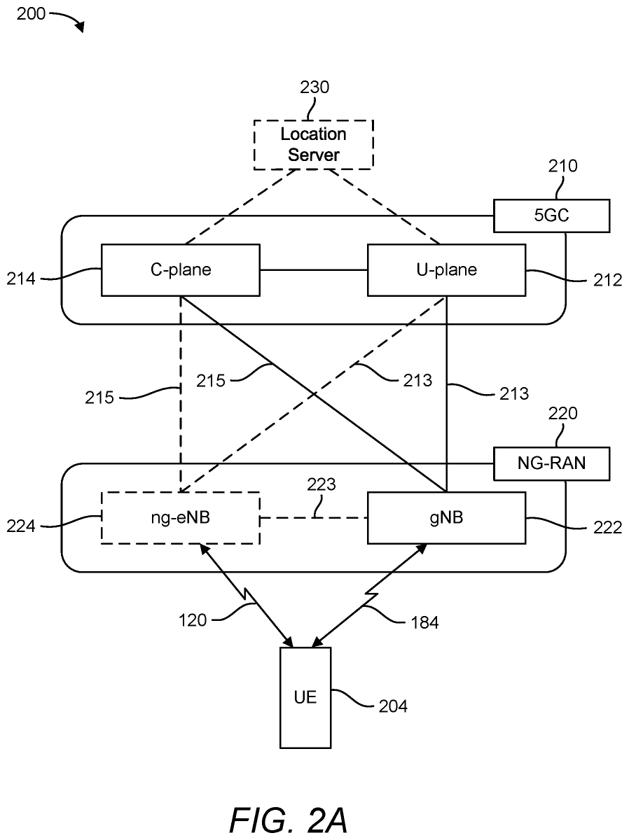

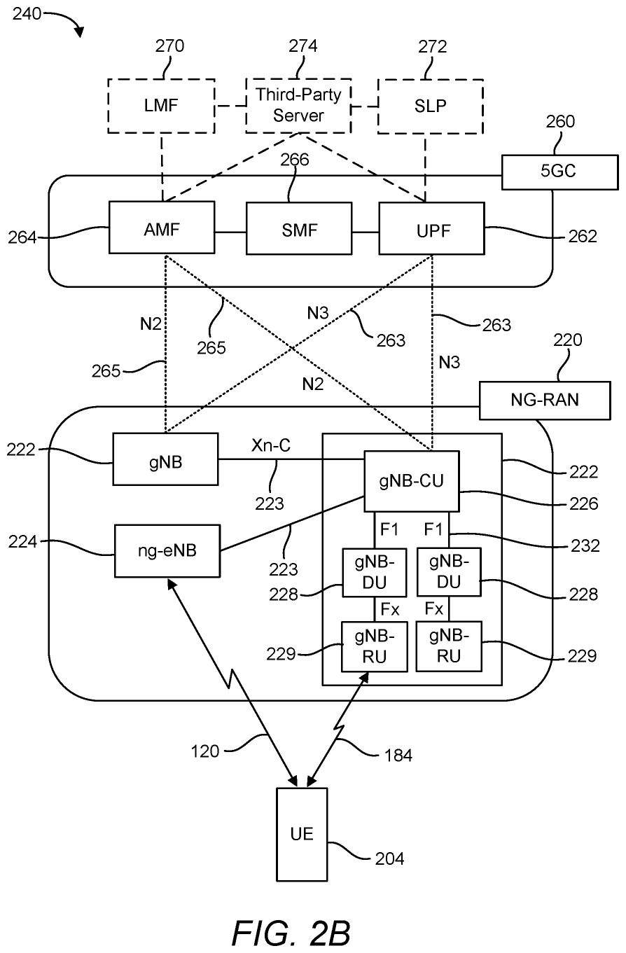

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F 1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

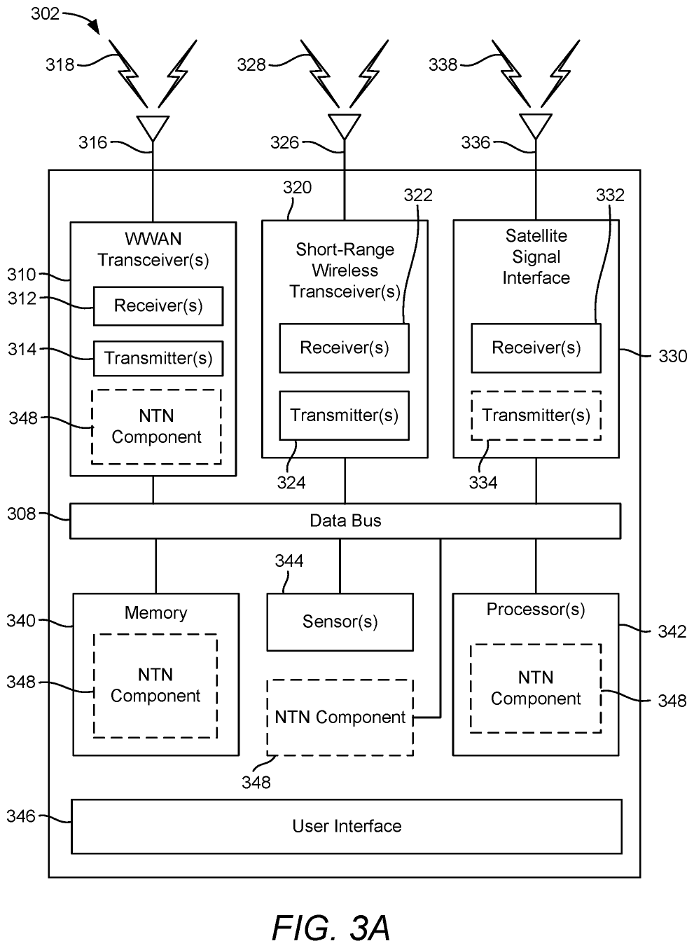

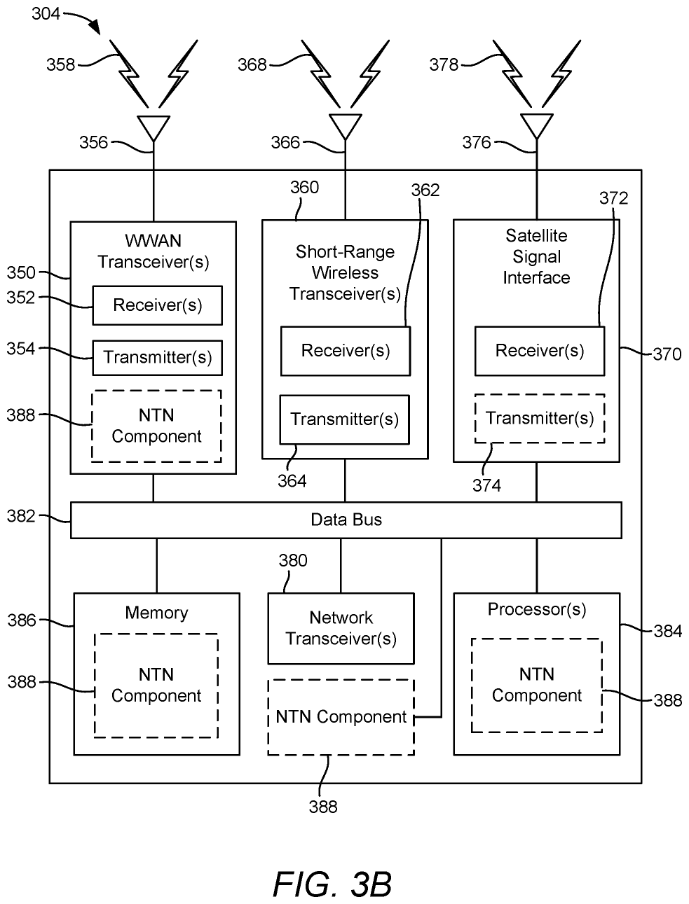

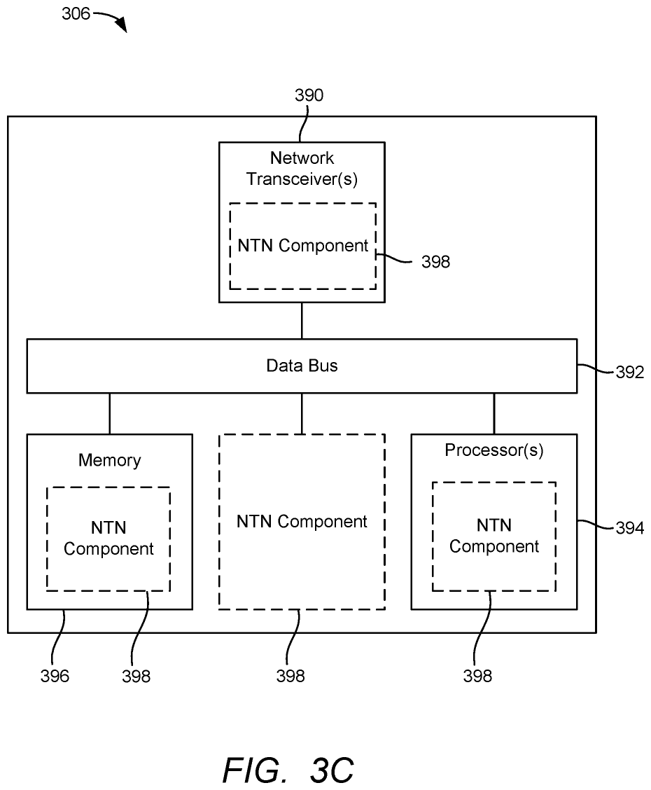

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include NTN component 348, 388, and 398, respectively. The NTN component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the NTN component 348, 388, and 398 may be external to the processors 342, 384, and 394 (e.g., part of a modem processing system, integrated with another processing system, etc.). Alternatively, the NTN component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the NTN component 348, which may be, for example, part of the one or more WWAN transceivers 310, the memory 340, the one or more processors 342, or any combination thereof, or may be a standalone component. FIG. 3B illustrates possible locations of the NTN component 388, which may be, for example, part of the one or more WWAN transceivers 350, the memory 386, the one or more processors 384, or any combination thereof, or may be a standalone component. FIG. 3C illustrates possible locations of the NTN component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIB s)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TB s), demultiplexing of MAC SDUs from TB s, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the NTN component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

In satellite communication scenarios, it is important to align the main antenna lobe (or main beam) of the wireless user device with the line-of-sight (LOS) direction to the space vehicle due to the generally lower transmit power capabilities of the wireless user device and large path loss. For example, some wireless user devices provide an emergency satellite connectivity feature that gives users the ability to send emergency (SOS) messages via satellite. Because user devices generally have lower transmit power capabilities, sending an SOS message via satellite generally requires an unobstructed path to the space vehicle. Orienting the device so that the main antenna lobe is aligned with the LOS direction to the space vehicle is therefore very important to meet the link budget (i.e., the transmit power necessary for the emergency signal to be received at the space vehicle with acceptable signal-to-noise ratio (SNR)).

As another example, NTN connectivity is a feature of 5G NR and is important for service continuity. In this case, link budget and UE power consumption concerns, as well as the frequency bands used for NTN services, make beamforming at the UE challenging. As such, orienting the UE so that its antenna lobe is aligned with the direction of the space vehicle is highly desirable. Doing so can save power and reduce the bill of materials (BOM) (resulting in savings in the costs of the amplifier, antenna, etc.), for example.

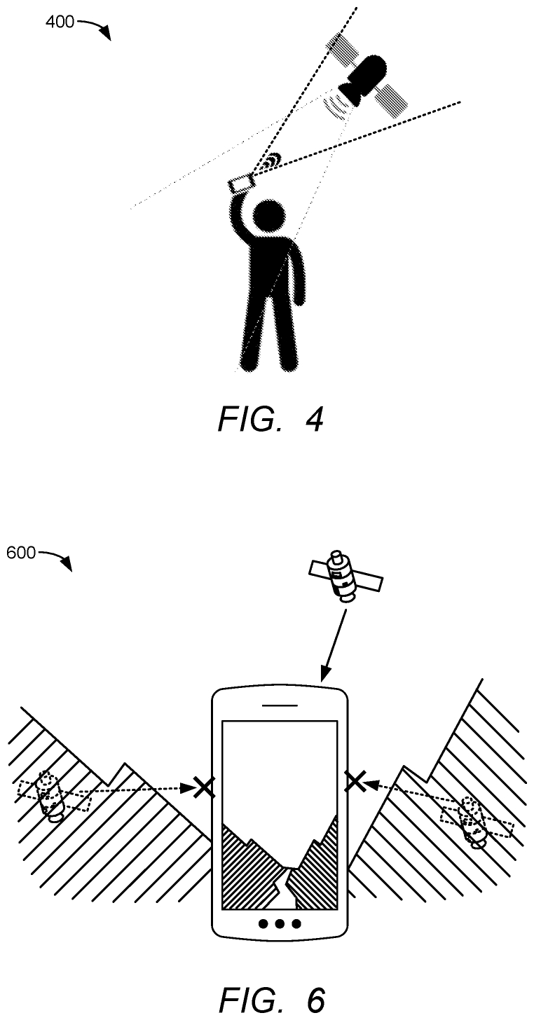

FIG. 4 is a diagram 400 illustrating an NTN communication scenario in which the user is orienting a mobile device (e.g., a smartphone) towards a space vehicle, according to aspects of the disclosure. The NTN communication scenario may be, for example, a user-to-network scenario, such as an emergency message via satellite scenario, or a user-to-user communication scenario, such as a text message or phone call. As shown in FIG. 4, the user is physically orienting the device to achieve antenna-to-space vehicle alignment. Specifically, the user is orienting the device towards the space vehicle, thereby aligning the main antenna lobe with the LOS direction to the space vehicle.

Note that the radiation pattern of most antennas is a pattern of “lobes” at various angles, i.e., directions where the radiated signal strength reaches a maximum, separated by “nulls,” i.e., angles at which the radiation falls to zero. In a directional/beamforming antenna, where the objective is to emit radio waves in a particular direction, the lobe in that direction is designed to have higher field strength than the other lobes and is referred to as the “main lobe” (or “main antenna lobe” or the like). In an NTN communication scenario, the main lobe is a cone approximately 30 degrees wide. The other lobes are referred to as “sidelobes” and usually represent unwanted radiation in undesired directions. The main lobe of a handheld smartphone typically radiates out the back of the device, but may in some cases radiate out the front of the device or in some other direction. As such, the device may prompt the user to orient the device so that the rear-facing camera points towards the space vehicle.

Over time, space vehicles can have good coverage of the whole sky. For example, the orbital plane of Iridium NEXT satellites (a type of communication satellite) sweeps the whole sky in approximately two hours. These satellites travel in six North-South orbital planes. As the Earth rotates eastward, an orbital plane on the east with respect to a given user location will gradually move west. The orbital planes are spaced by approximately 31.6 degrees. Since the Earth rotates at about 15 degrees per hour, the satellites will traverse the whole sky in about 2.1 hours.

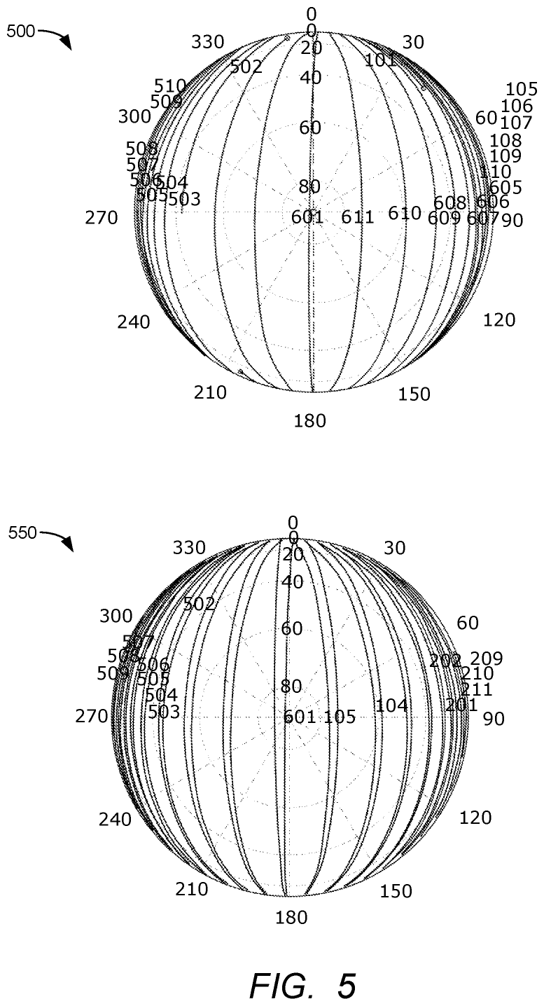

FIG. 5 illustrates two example sky plots of the trajectories of Iridium NEXT satellites as viewed from San Diego, California, according to aspects of the disclosure. A sky plot represents the locations and movement of heavenly bodies relative to an observation point on Earth (e.g., San Diego). More specifically, the center of the circle corresponds to the observation point (e.g., a user, a device, a city center, etc.). Azimuth angles relative to the observation point are represented as lines radiating out from the center. For example, North from the observation point is 0 degrees, South is 180 degrees, and so on. Elevation angles relative to the observation point are represented as concentric circles around the center. The outside circle represents the horizon at 0 degrees, and the elevation angles increase to 90 degrees (i.e., straight up from the observation point) at the center.

In the example of FIG. 5, sky plot 500 illustrates the trajectories of Iridium NEXT satellites over two hours, while sky plot 550 illustrates their trajectories over four hours. The trajectories shown in the sky plots 500 and 550 correspond to each satellite in an orbit plane. There may be multiple satellites in the same orbit, for example, 11 Iridium NEXT satellites in each orbit. This appears as 11 distinct North-South lines in the sky plots 500 and 550.

While space vehicles provide good coverage of the sky, there are times when a mobile device may be at a location where it is blocked from having a LOS view of a space vehicle due to an obstruction, such as a hillside, a building, a forest, or the like. FIG. 6 is a diagram 600 illustrating an example scenario in which a set of space vehicles is blocked from the view of a mobile device (e.g., a smartphone) by a mountainside, according to aspects of the disclosure. In the example of FIG. 6, there is a search space of a set of three space vehicles (although there may be more or fewer) that are expected to be in view of the mobile device at its current location. The set of space vehicles expected to be in view of the mobile device (i.e., the search space) may be determined by cross-referencing the current location of the mobile device with ephemeris data indicating the paths of the space vehicles (e.g., Iridium NEXT satellites). The mobile device may have obtained the ephemeris data by downloading it when connected to a terrestrial network.

As shown in FIG. 6, the set of space vehicles with which the mobile device can communicate is limited to only one space vehicle instead of the three in the search space at the mobile device's current location. However, without knowledge of the obstruction (here, the mountainside), the mobile device may attempt to search for all (here, three) space vehicles expected to be in view at its location. This can be a significant drain on the battery of the device. Accordingly, the present disclosure provides techniques to optimize the search space for the direction in which a device should point in order to align the main antenna lobe with the LOS direction to a space vehicle.

As a first technique described herein, 3D maps can be used to identify obstructions and determine whether and how to remove NTN space vehicles from the search space based on mapped obstructions (e.g., mountains, tall buildings, etc.). For example, if the mobile device is located on the west side of a mountain, space vehicles on the east side of the mountain may be excluded until a line-of-sight is expected to be available from the space vehicle from the search space of space vehicles expected to be in view of the mobile device at its current location. As another example, if the mobile device is located between two tall buildings, space vehicles on the other sides of the buildings from the mobile device will be excluded from the search space.

More specifically, the location of the mobile device can be determined using GNSS or some terrestrial positioning technique and that position can be identified on a 3D map stored on the device. Obstructions within some distance from the mobile device can then be identified. The distance may depend on the size of the obstruction. For example, a ten-story building may be considered an obstruction only if the mobile device is within 500 feet of it, whereas a mountain may be considered an obstruction even if the mobile device is a mile away. Once the obstruction(s) have been identified, any space vehicles on the other side of the obstruction(s) from the mobile device can be excluded from the search space until a line-of-sight is expected to be available from the space vehicle.

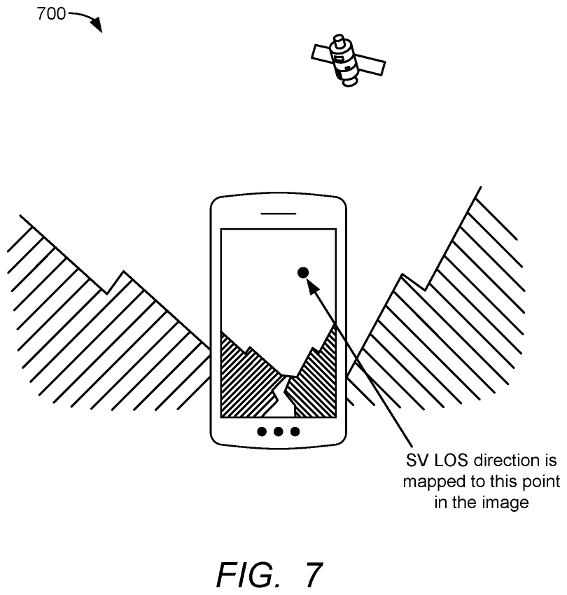

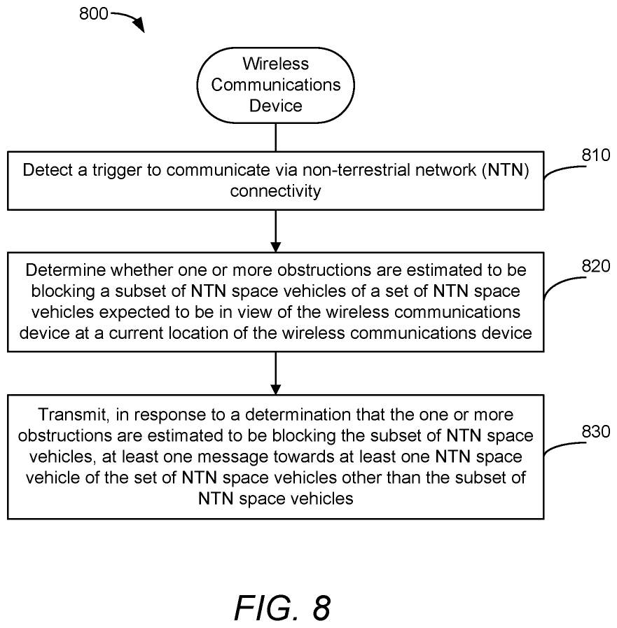

As a second technique, camera data (e.g., image(s) and/or video data captured by a camera of the mobile device) and object recognition techniques can be used to identify obstructions and determine whether and how to remove NTN space vehicles from the search space. FIG. 7 is a diagram 700 illustrating an example scenario in which the camera of a mobile device is used to determine whether there is a LOS path to a space vehicle, according to aspects of the disclosure. As shown in FIG. 7, the camera of the mobile device is capturing an image or video of the surrounding environment. In an aspect, the camera data can be obtained during the pointing process described above with reference to FIG. 4. Alternatively, the user can be prompted to capture the camera data. For example, the user may be requested to take, for example, a 45-degree, 90-degree, 360-degree, or other video at the user's current location.

The direction to the space vehicle can be mapped to a point in the captured image by transforming the space vehicle direction to the device body frame and calculating a 3D (or 2D) perspective projection through a virtual lens matched to the actual camera setting. More specifically, the space vehicle's azimuth and/or elevation position with respect to the current location of the mobile device can be obtained based on a previously downloaded database of space vehicle ephemeris data and the current global navigation satellite system (GNSS) fix (location and time) of the mobile device. Combined with the device's orientation (relative to the Earth) and the orientation of the mobile device's camera, the LOS direction to the space vehicle can be converted to a vector in the camera's local 3D frame. This LOS vector (i.e., direction) can be mapped to a specific point in the image (and approximately a certain pixel in the image) using perspective projection based on the actual camera's parameters (e.g., field of view (FOV), focal distance, image size, principal point, etc.).

Intuitively, the identified point is the imaging of a virtual incoming ray of light from the space vehicle. This allows the camera to “see” the space vehicle, and if the position of the space vehicle overlaps with a recognized object (e.g., hillside, tree(s), building(s), etc.) then it can be determined that the LOS direction is obstructed. The space vehicle associated with the obstructed point can then be excluded from the search space. Ideally, if the LOS point does not overlay with any blocking objects in the image, as in the example of FIG. 7, then it is considered not obstructed. Practically, however, some margin (e.g., some threshold distance) may be considered, due to the inherent noise in the foregoing calculations and the likelihood that the device is not being held perfectly steady. Some look-ahead can also be considered, as the space vehicle will typically be moving over time from the perspective of the mobile device. The process may be repeated for each space vehicle in the search space of space vehicles expected to be in view of the mobile device at its current location.

In an aspect, the obstruction may be classified via computer vision (e.g., as a hillside, tree(s), building(s), etc.), and that classification may be stored and transmitted to the network, either via NTN connectivity, cellular connectivity, or other terrestrial connectivity (e.g., Wi-Fi). In an aspect, the mobile device may also bulk upload when it is plugged in and has a WLAN connection (e.g., Wi-Fi) available.

As will be appreciated, the second technique can complement the first technique (i.e., using 3D maps) by providing a more local view of the terrain, possibly without requiring a high-resolution download of the 3D map. In addition, it is not necessary to actually show any image on the screen of the mobile device, the processing could instead be performed without involving the user interface (UI).

For example, the mobile device may preemptively (prior to moving out of terrestrial network coverage) receive a sparse map feature set to enable localization via camera without GNSS to help aid NTN searching. In the transmission to the NTN space vehicle, the mobile device may provide a sparse map feature set of its surroundings to enable a cloud entity to determine the mobile device's location or to help augment the mobile device's location (in addition to the mobile device's reported GNSS position). Such a sparse map feature set may also be stored for transmission at a later time if the mobile device only reports its GNSS position, or if the mobile device only reports which feature sets were found from the preemptively received sparse map feature set. The mobile device can report any deviations and/or unknown map feature sets when the mobile device regains terrestrial cellular coverage or other terrestrial connectivity (e.g., Wi-Fi. In an aspect, the mobile device may also bulk upload when it is plugged in and has a WLAN connection (e.g., Wi-Fi) available.

As a third technique, crowdsourcing can be used to identify obstructions and determine whether and how to remove NTN space vehicles from the search space. This technique assumes that the mobile device's location (latitude and longitude), orientation relative to True North, and altitude (if available) are known. In greater detail, the mobile device may be (pre-)configured with a table or list that includes excluded azimuth and/or elevation region(s) per GPS cell (referred to as an “exclusion list,” “exclusion table,” “obstruction list,” “obstruction table,” or the like). The exclusion list may be configured to the mobile device when it is connected to a terrestrial network, similar to the way it is configured with ephemeris data. Alternatively or additionally, the mobile device may be able to download parts of the table using NTN connectivity (in which case it may be limited to nearby cells due to the limited amount of traffic that can be communicated via NTN connectivity). The mobile device may have the ability to selectively download only a portion of the exclusion table relevant to a specific geographic region.

The exclusion list may be arranged as an array or grid of GPS cells (e.g., 25 meters by 25 meters or based on GPS accuracy) and include, for each cell, excluded azimuth and/or elevation angles relative to a fixed direction (e.g., True North). That is, the obstruction may be defined in terms of a direction vector with respect to a reference direction. Since the exclusion shape within and/or across cells may be two-dimensional, three-dimensional, and/or irregular, an approximation or some sort of area/volume-based information may be provided to encode the limits of this irregular shape. Note that the antenna orientation of the mobile device is expected to be known when the obstruction is determined. In addition, the number of antennas and their relative orientation is expected to be part of the definition of the orientation of the mobile device.

The mobile device (or more specifically, the pointing algorithm) can determine the applicable GPS cell based on the current location of the mobile device. Based on the mobile device's location, orientation relative to True North, altitude (if available), and the exclusion list, the mobile device can extract the applicable excluded azimuth and/or elevation regions from the table and transform them appropriately. Note that if the exclusion list has no values for a particular GPS cell, that cell is considered to have no exclusions.

The results of a failure of the mobile device to acquire (communicate with) an NTN space vehicle against a particular azimuth and/or elevation angle are recorded in a local database. The mobile device may record the following parameters in the database: (1) GPS location, (2) mobile device orientation, (3) altitude, (4) direction of True North, (5) time of day, (6) the failure signal (e.g., initial ring search failure, ring scan failure (for the intended beam or broadcast channel (BCCH) failure)), (7) the failure type (e.g., burst not found, burst missed synchronization), (8) the failure rate (e.g., intermittency of failure (in case the failure is seen in the ring monitor)), (9) the observed signal strength (applicable if there is a missed synchronization) and other possible downlink metrics (e.g., frequency offset), (10) the mobile device's unique identification number (e.g., international mobile equipment identity (IMEI)), and/or (11) the unique ID of the space vehicle, beam ID, cell ID, and/or carrier frequency information (if applicable and available prior to the mobile device attempting acquisition of the space vehicle).

The mobile device sends the collected data to a server (e.g., a crowd source failure database server) when it reacquires access to a terrestrial network. The validity of the collected data can be cross verified against the existing known exclusion data. Once verified, the server can incorporate this newly received crowd-sourced data into the exclusion list, which is can then disseminate to all mobile devices in its coverage area.

With this technique, permanent and/or semi-permanent obstructions can be identified. The criteria for identifying semi-permanent obstructions may be linked to the rate at which the exclusion table is updated by the mobile device.

Note that the information collected and reported by the mobile device in the case of a failure may be used for overall network operations, administration, and maintenance (OAM).

In some cases, the user may wish for the mobile device to send a message autonomously (i.e., without the user physically orienting the mobile device such that the main antenna lobe is aligned with the LOS direction to a space vehicle). For example, the user may wish to set the mobile device down to perform other activities while the device transmits. As another example, the user may be injured and unable to physically orient the device. As yet another example, in an IoT over NTN scenario, the mobile device may be affixed to an object that is not moveable or unable to be moved for a certain duration (e.g., an asset tracker on a package). In such cases, it might take many minutes to hours for a space vehicle to be visible to the mobile device. In addition, the window of opportunity could be very narrow (e.g., less than a minute).

A “dumb” solution to the above issues would be to persistently scan for NTN space vehicles looking for one with a sufficient received SNR. However, this may use up a substantial amount of battery charge. Accordingly, the present disclosure provides techniques for using sensors and GNSS signals to predict the best time for the mobile device to scan.

Usually there are multiple GNSS space vehicles in view of a mobile device. Although GNSS antenna patterns are not identical to NTN antenna patterns, they may be similar enough to estimate properties of the NTN antenna patterns. Each GNSS space vehicle's signal strength is a function of transmit power, path loss, and antenna gain. The path loss of the LOS path and the GNSS space vehicle's transmit power are known or can be estimated, leaving antenna gain. The antenna gain can be estimated, however, using multiple measurements and empirical or machine learning modelling. Knowledge of the NTN space vehicles' orbits (from ephemeris data) and antenna models (i.e., the models of the antenna gains) can then be used to predict favorable epochs (i.e., periods of time during which the main antenna lobe will be sufficiently aligned with the LOS direction to a space vehicle for the mobile device to attempt transmission).

A benefit of this technique is that is reduces the search space (by reducing the time of the search and thereby reducing the number of space vehicles to those in view during the time period of the search) to avoid draining the battery. For example, the duty cycle may be reduced from 20% to less than 5%. Another benefit is that the user can be warned of an excessive wait time. For example, the user could be alerted if the estimated time to connection is more than some number of minutes (e.g., 20 minutes). In such a case, the user could be given a suggestion for a better orientation of the mobile device.

The above technique is also applicable to active pointing scenarios. Testing data indicates that a third or more of the time, the best space vehicle to point to is not the nearest one or even one without obstructions. For example, some secondary lobes might also exist and be sufficient for NTN transmission. By predicting favorable epochs (e.g., based on the space vehicles' paths and modeled antenna gains), the user can be directed to point to a favorable space vehicle, which may not be the closest or least obstructed. This could thereby reduce session duration.

The above technique is also applicable to identifying obstructions and determining whether and how to remove NTN space vehicles from the search space. Specifically, because there are typically multiple GNSS space vehicles in view of a mobile device, if a mobile device cannot detect GNSS space vehicles in a particular azimuth/elevation region, it will probably also not be able to detect NTN space vehicles in that region. As such, such regions may be considered to correspond to obstructions.

FIG. 8 illustrates an example method 800 of wireless communication, according to aspects of the disclosure. In an aspect, method 800 may be performed by a wireless communications device (e.g., any of the UEs or other mobile devices described herein).

At 810, the wireless communications device detects a trigger to communicate via NTN connectivity. In an aspect, operation 810 may be performed by the one or more WWAN transceivers 310, the one or more processors 342, memory 340, and/or NTN component 348, any or all of which may be considered means for performing this operation.

At 820, the wireless communications device determines whether one or more obstructions are estimated to be blocking a subset of NTN space vehicles of a set of NTN space vehicles expected to be in view of the wireless communications device at a current location of the wireless communications device. In an aspect, operation 820 may be performed by the one or more WWAN transceivers 310, the one or more processors 342, memory 340, and/or NTN component 348, any or all of which may be considered means for performing this operation.

At 830, the wireless transmits, in response to a determination at 820 that the one or more obstructions are estimated to be blocking the subset of NTN space vehicles, at least one message (e.g., an emergency message) towards at least one NTN space vehicle of the set of NTN space vehicles other than the subset of NTN space vehicles. In an aspect, operation 830 may be performed by the one or more WWAN transceivers 310, the one or more processors 342, memory 340, and/or NTN component 348, any or all of which may be considered means for performing this operation.

As will be appreciated, a technical advantage of the method 800 is reduced latency (and therefore reduced power consumption) and improved reliability of NTN connectivity by reducing the size of the search space of NTN space vehicles to unobstructed NTN space vehicles.

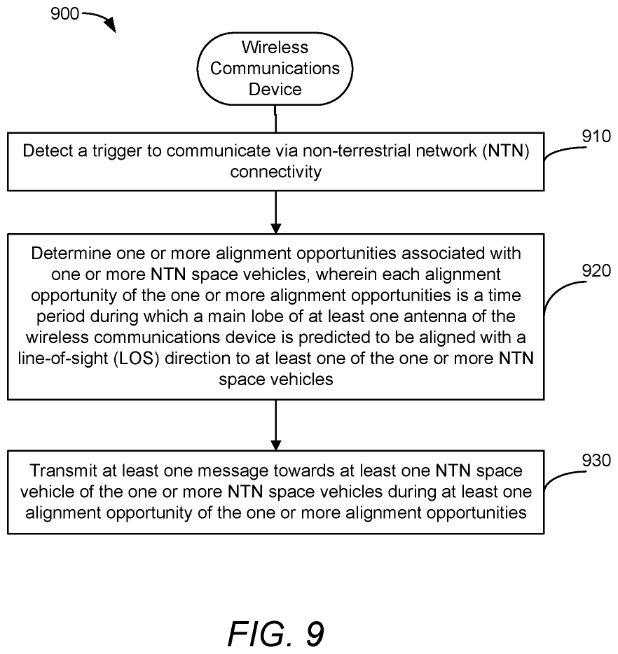

FIG. 9 illustrates an example method 900 of wireless communication, according to aspects of the disclosure. In an aspect, method 900 may be performed by a wireless communications device (e.g., any of the UEs or other mobile devices described herein).

At 910, the wireless communications device detects a trigger to communicate via NTN connectivity. In an aspect, operation 910 may be performed by the one or more WWAN transceivers 310, the one or more processors 342, memory 340, and/or NTN component 348, any or all of which may be considered means for performing this operation.

At 920, the wireless communications device determines one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles. In an aspect, operation 920 may be performed by the one or more WWAN transceivers 310, the one or more processors 342, memory 340, and/or NTN component 348, any or all of which may be considered means for performing this operation.

At 930, the wireless communications device transmits at least one message (e.g., an emergency message) towards at least one NTN space vehicle of the one or more NTN space vehicles during at least one alignment opportunity of the one or more alignment opportunities. In an aspect, operation 940 may be performed by the one or more WWAN transceivers 310, the one or more processors 342, memory 340, and/or NTN component 348, any or all of which may be considered means for performing this operation.

As will be appreciated, a technical advantage of the method 900 is reduced time to acquire NTN connectivity and therefore improved power consumption in NTN connectivity scenarios. Additional advantages include ease of use, in that it does not require manual adjustment to the device orientation, which a user may not be capable of performing.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a wireless communications device, comprising: detecting a trigger to communicate via non-terrestrial network (NTN) connectivity; determining that one or more obstructions are blocking a subset of NTN space vehicles of a set of NTN space vehicles expected to be in view of the wireless communications device at a current location of the wireless communications device; and attempting to communicate (e.g., transmitting a message, receiving a message, or both) with at least one NTN space vehicle of the set of NTN space vehicles other than the subset of NTN space vehicles.

Clause 2. The method of clause 1, wherein determining that the one or more obstructions are blocking the subset of NTN space vehicles comprises: identifying the one or more obstructions on a map of a geographic area in which the wireless communications device is located; and determining that the one or more obstructions are within a threshold distance of the current location of the wireless communications device.

Clause 3. The method of clause 2, wherein determining that the one or more obstructions are blocking the subset of NTN space vehicles comprises: determining that the subset of NTN space vehicles is on an opposite side of or above the one or more obstructions from the wireless communications device.

Clause 4. The method of any of clauses 2 to 3, wherein the map comprises: a two-dimensional (2D) map, a three-dimensional (3D) map, or a high-definition (HD) map.

Clause 5. The method of any of clauses 1 to 4, wherein determining that the one or more obstructions are blocking the subset of NTN space vehicles comprises: obtaining image data from at least one camera of the wireless communications device; identifying the one or more obstructions within the image data; determining direction vectors from the wireless communications device to the set of NTN space vehicles; identifying positions of the set of NTN space vehicles within the image data based on the direction vectors; and determining that positions of the subset of NTN space vehicles overlay the one or more obstructions.

Clause 6. The method of clause 5, wherein the one or more obstructions are identified within the image data based on object recognition performed on the image data.

Clause 7. The method of any of clauses 5 to 6, wherein determining the direction vectors comprises: determining azimuth and elevation angles of the set of NTN space vehicles with respect to the wireless communications device based on ephemeris data for the set of NTN space vehicles and a global navigation satellite system (GNSS) position fix of the wireless communications device; and determining the direction vectors based on the azimuth and elevation angles and an orientation of the at least one camera.

Clause 8. The method of any of clauses 5 to 7, wherein identifying the positions of the set of NTN space vehicles within the image data comprises: mapping the direction vectors to points in the image data using perspective projection based on parameters of the at least one camera.

Clause 9. The method of any of clauses 5 to 8, wherein determining that the positions of the subset of NTN space vehicles overlay the one or more obstructions comprises: determining that the positions of the subset of NTN space vehicles overlay the one or more obstructions by at least a threshold distance.

Clause 10. The method of any of clauses 5 to 9, further comprising: prompting a user of the wireless communications device to capture the image data with the at least one camera of the wireless communications device.

Clause 11. The method of any of clauses 1 to 10, wherein determining that the one or more obstructions are blocking the subset of NTN space vehicles comprises: obtaining a crowdsourced obstruction table associated with the current location of the wireless communications device; and determining that the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 12. The method of clause 11, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 13. The method of clause 12, wherein the shape information for the one or more obstructions comprises: a subset of cells of the plurality of cells corresponding to the one or more obstructions, or sub-regions within cells of the plurality of cells corresponding to the one or more obstructions.

Clause 14. The method of clause 13, wherein the sub-regions within the cells of the plurality of cells comprise azimuth and elevation regions with respect to a fixed reference direction for the one or more obstructions within the cells of the plurality of cells.

Clause 15. The method of any of clauses 12 to 14, wherein a size of the plurality of cells is: fixed, or based on an accuracy of the position fix of the wireless communications device.

Clause 16. The method of any of clauses 11 to 15, wherein the crowdsourced obstruction table is obtained via: a terrestrial network, NTN connectivity, or any combination thereof.

Clause 17. The method of any of clauses 11 to 16, wherein the one or more obstructions are determined to be blocking the subset of NTN space vehicles further based on direction vectors from the wireless communications device to the subset of NTN space vehicles.

Clause 18. The method of any of clauses 11 to 17, further comprising: collecting one or more parameters associated with the subset of NTN space vehicles being blocked by the one or more obstructions; and reporting the one or more parameters to a terrestrial network server via terrestrial network connectivity or NTN connectivity.

Clause 19. The method of clause 18, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 20. The method of any of clauses 1 to 19, wherein determining that the one or more obstructions are blocking the subset of NTN space vehicles comprises: detecting a set of GNSS space vehicles in view of the wireless communications device at the current location of the wireless communications device; identifying one or more azimuth and elevation regions that are not occupied by the set of GNSS space vehicles; and determining the one or more obstructions as the one or more azimuth and elevation regions.

Clause 21. The method of any of clauses 1 to 20, wherein the wireless communications device is not connected to a terrestrial wireless communications network.

Clause 22. The method of any of clauses 1 to 21, wherein detecting the trigger comprises: receiving a request from a user or another component (e.g., as in the IoT case) of the wireless communications device to communicate via NTN connectivity; detecting an emergency event at the wireless communications device; or any combination thereof.

Clause 23. The method of any of clauses 1 to 22, wherein attempting to communicate with the at least one space vehicle comprises: transmitting a message to the at least one NTN space vehicle.

Clause 24. A method of wireless communication performed by a wireless communications device, comprising: detecting a trigger to communicate via non-terrestrial network (NTN) connectivity; determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; refraining from communicating with the one or more NTN space vehicles until at least one alignment opportunity of the one or more alignment opportunities; and attempting to communicate with at least one NTN space vehicle of the one or more NTN space vehicles during the at least one alignment opportunity of the one or more alignment opportunities.

Clause 25. The method of clause 24, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 26. The method of clause 25, wherein the transmission characteristics comprise an estimated transmit power, path loss, and antenna gain of the set of GNSS space vehicles.

Clause 27. The method of any of clauses 25 to 26, wherein the antenna gain is determined based on: multiple measurements of the set of GNSS space vehicles, an empirical model of the antenna gain, a machine learning model of the antenna gain, or any combination thereof.

Clause 28. The method of any of clauses 24 to 27, further comprising: determining that the one or more alignment opportunities will not occur within a threshold period of time of a current time; and prompting a user of the wireless communications device to reposition the wireless communications device.

Clause 29. The method of any of clauses 24 to 28, wherein refraining from communicating with the one or more NTN space vehicles comprises: transitioning to a sleep state until the at least one alignment opportunity of the one or more alignment opportunities.

Clause 30. The method of any of clauses 24 to 29, further comprising: notifying a user of the wireless communications device of a time of a next alignment opportunity of the one or more alignment opportunities.

Clause 31. The method of any of clauses 24 to 30, wherein detecting the trigger comprises: receiving a request from a user or another component of the wireless communications device to communicate via NTN connectivity; detecting an emergency event at the wireless communications device; determining that the user is incapable of performing an interactive pointing procedure with the wireless communications device; or any combination thereof.

Clause 32. The method of any of clauses 24 to 31, wherein the wireless communications device is not connected to a terrestrial wireless communications network.

Clause 33. The method of any of clauses 24 to 32, wherein attempting to communicate with the at least one space vehicle comprises: transmitting a message to the at least one NTN space vehicle.

Clause 34. A wireless communications device, comprising: a memory; at least one transceiver; and at least one processor communicatively coupled to the memory and the at least one transceiver, the at least one processor configured to: detect a trigger to communicate via non-terrestrial network (NTN) connectivity; determine that one or more obstructions are blocking a subset of NTN space vehicles of a set of NTN space vehicles expected to be in view of the wireless communications device at a current location of the wireless communications device; and attempt to communicate with at least one NTN space vehicle of the set of NTN space vehicles other than the subset of NTN space vehicles.

Clause 35. The wireless communications device of clause 34, wherein the at least one processor configured to determine that the one or more obstructions are blocking the subset of NTN space vehicles comprises the at least one processor configured to: identify the one or more obstructions on a map of a geographic area in which the wireless communications device is located; and determine that the one or more obstructions are within a threshold distance of the current location of the wireless communications device.

Clause 36. The wireless communications device of clause 35, wherein the at least one processor configured to determine that the one or more obstructions are blocking the subset of NTN space vehicles comprises the at least one processor configured to: determine that the subset of NTN space vehicles is on an opposite side of or above the one or more obstructions from the wireless communications device.

Clause 37. The wireless communications device of any of clauses 35 to 36, wherein the map comprises: a two-dimensional (2D) map, a three-dimensional (3D) map, or a high-definition (HD) map.

Clause 38. The wireless communications device of any of clauses 34 to 37, wherein the at least one processor configured to determine that the one or more obstructions are blocking the subset of NTN space vehicles comprises the at least one processor configured to: obtain image data from at least one camera of the wireless communications device; identify the one or more obstructions within the image data; determine direction vectors from the wireless communications device to the set of NTN space vehicles; identify positions of the set of NTN space vehicles within the image data based on the direction vectors; and determine that positions of the subset of NTN space vehicles overlay the one or more obstructions.

Clause 39. The wireless communications device of clause 38, wherein the one or more obstructions are identified within the image data based on object recognition performed on the image data.

Clause 40. The wireless communications device of any of clauses 38 to 39, wherein the at least one processor configured to determine the direction vectors comprises the at least one processor configured to: determine azimuth and elevation angles of the set of NTN space vehicles with respect to the wireless communications device based on ephemeris data for the set of NTN space vehicles and a global navigation satellite system (GNSS) position fix of the wireless communications device; and determine the direction vectors based on the azimuth and elevation angles and an orientation of the at least one camera.

Clause 41. The wireless communications device of any of clauses 38 to 40, wherein the at least one processor configured to identify the positions of the set of NTN space vehicles within the image data comprises the at least one processor configured to: map the direction vectors to points in the image data using perspective projection based on parameters of the at least one camera.

Clause 42. The wireless communications device of any of clauses 38 to 41, wherein the at least one processor configured to determine that the positions of the subset of NTN space vehicles overlay the one or more obstructions comprises the at least one processor configured to: determine that the positions of the subset of NTN space vehicles overlay the one or more obstructions by at least a threshold distance.

Clause 43. The wireless communications device of any of clauses 38 to 42, wherein the at least one processor is further configured to: prompt a user of the wireless communications device to capture the image data with the at least one camera of the wireless communications device.

Clause 44. The wireless communications device of any of clauses 34 to 43, wherein the at least one processor configured to determine that the one or more obstructions are blocking the subset of NTN space vehicles comprises the at least one processor configured to: obtain a crowdsourced obstruction table associated with the current location of the wireless communications device; and determine that the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 45. The wireless communications device of clause 44, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 46. The wireless communications device of clause 45, wherein the shape information for the one or more obstructions comprises: a subset of cells of the plurality of cells corresponding to the one or more obstructions, or sub-regions within cells of the plurality of cells corresponding to the one or more obstructions.

Clause 47. The wireless communications device of clause 46, wherein the sub-regions within the cells of the plurality of cells comprise azimuth and elevation regions with respect to a fixed reference direction for the one or more obstructions within the cells of the plurality of cells.

Clause 48. The wireless communications device of any of clauses 45 to 47, wherein a size of the plurality of cells is: fix, or base on an accuracy of the position fix of the wireless communications device.

Clause 49. The wireless communications device of any of clauses 44 to 48, wherein the crowdsourced obstruction table is obtained via: a terrestrial network, NTN connectivity, or any combination thereof.

Clause 50. The wireless communications device of any of clauses 44 to 49, wherein the one or more obstructions are determined to be blocking the subset of NTN space vehicles further based on direction vectors from the wireless communications device to the subset of NTN space vehicles.

Clause 51. The wireless communications device of any of clauses 44 to 50, wherein the at least one processor is further configured to: collect one or more parameters associated with the subset of NTN space vehicles being blocked by the one or more obstructions; and report, via the at least one transceiver, the one or more parameters to a terrestrial network server via terrestrial network connectivity or NTN connectivity.

Clause 52. The wireless communications device of clause 51, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 53. The wireless communications device of any of clauses 34 to 52, wherein the at least one processor configured to determine that the one or more obstructions are blocking the subset of NTN space vehicles comprises the at least one processor configured to: detect a set of GNSS space vehicles in view of the wireless communications device at the current location of the wireless communications device; identify one or more azimuth and elevation regions that are not occupied by the set of GNSS space vehicles; and determine the one or more obstructions as the one or more azimuth and elevation regions.

Clause 54. The wireless communications device of any of clauses 34 to 53, wherein the wireless communications device is not connected to a terrestrial wireless communications network.

Clause 55. The wireless communications device of any of clauses 34 to 54, wherein the at least one processor configured to detect the trigger comprises the at least one processor configured to: receive, via the at least one transceiver, a request from a user or another component of the wireless communications device to communicate via NTN connectivity; detect an emergency event at the wireless communications device; or any combination thereof.

Clause 56. The wireless communications device of any of clauses 34 to 55, wherein the at least one processor configured to attempt to communicate with the at least one space vehicle comprises the at least one processor configured to: transmit, via the at least one transceiver, a message to the at least one NTN space vehicle.

Clause 57. A wireless communications device, comprising: a memory; at least one transceiver; and at least one processor communicatively coupled to the memory and the at least one transceiver, the at least one processor configured to: detect a trigger to communicate via non-terrestrial network (NTN) connectivity; determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; refrain from communicating with the one or more NTN space vehicles until at least one alignment opportunity of the one or more alignment opportunities; and attempt to communicate with at least one NTN space vehicle of the one or more NTN space vehicles during the at least one alignment opportunity of the one or more alignment opportunities.

Clause 58. The wireless communications device of clause 57, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 59. The wireless communications device of clause 58, wherein the transmission characteristics comprise an estimated transmit power, path loss, and antenna gain of the set of GNSS space vehicles.

Clause 60. The wireless communications device of any of clauses 58 to 59, wherein the antenna gain is determined based on: multiple measurements of the set of GNSS space vehicles, an empirical model of the antenna gain, a machine learning model of the antenna gain, or any combination thereof.

Clause 61. The wireless communications device of any of clauses 57 to 60, wherein the at least one processor is further configured to: determine that the one or more alignment opportunities will not occur within a threshold period of time of a current time; and prompt a user of the wireless communications device to reposition the wireless communications device.

Clause 62. The wireless communications device of any of clauses 57 to 61, wherein the at least one processor configured to refrain from communicating with the one or more NTN space vehicles comprises the at least one processor configured to: transition to a sleep state until the at least one alignment opportunity of the one or more alignment opportunities.

Clause 63. The wireless communications device of any of clauses 57 to 62, wherein the at least one processor is further configured to: notify a user of the wireless communications device of a time of a next alignment opportunity of the one or more alignment opportunities.

Clause 64. The wireless communications device of any of clauses 57 to 63, wherein the at least one processor configured to detect the trigger comprises the at least one processor configured to: receive, via the at least one transceiver, a request from a user or another component of the wireless communications device to communicate via NTN connectivity; detect an emergency event at the wireless communications device; determine that the user is incapable of performing an interactive pointing procedure with the wireless communications device; or any combination thereof.

Clause 65. The wireless communications device of any of clauses 57 to 64, wherein the wireless communications device is not connected to a terrestrial wireless communications network.

Clause 66. The wireless communications device of any of clauses 57 to 65, wherein the at least one processor configured to attempt to communicate with the at least one space vehicle comprises the at least one processor configured to: transmit, via the at least one transceiver, a message to the at least one NTN space vehicle.

Clause 67. A wireless communications device, comprising: means for detecting a trigger to communicate via non-terrestrial network (NTN) connectivity; means for determining that one or more obstructions are blocking a subset of NTN space vehicles of a set of NTN space vehicles expected to be in view of the wireless communications device at a current location of the wireless communications device; and means for attempting to communicate with at least one NTN space vehicle of the set of NTN space vehicles other than the subset of NTN space vehicles.

Clause 68. The wireless communications device of clause 67, wherein the means for determining that the one or more obstructions are blocking the subset of NTN space vehicles comprises: means for identifying the one or more obstructions on a map of a geographic area in which the wireless communications device is located; and means for determining that the one or more obstructions are within a threshold distance of the current location of the wireless communications device.

Clause 69. The wireless communications device of clause 68, wherein the means for determining that the one or more obstructions are blocking the subset of NTN space vehicles comprises: means for determining that the subset of NTN space vehicles is on an opposite side of or above the one or more obstructions from the wireless communications device.

Clause 70. The wireless communications device of any of clauses 68 to 69, wherein the map comprises: a two-dimensional (2D) map, a three-dimensional (3D) map, or a high-definition (HD) map.

Clause 71. The wireless communications device of any of clauses 67 to 70, wherein the means for determining that the one or more obstructions are blocking the subset of NTN space vehicles comprises: means for obtaining image data from at least one camera of the wireless communications device; means for identifying the one or more obstructions within the image data; means for determining direction vectors from the wireless communications device to the set of NTN space vehicles; means for identifying positions of the set of NTN space vehicles within the image data based on the direction vectors; and means for determining that positions of the subset of NTN space vehicles overlay the one or more obstructions.

Clause 72. The wireless communications device of clause 71, wherein the one or more obstructions are identified within the image data based on object recognition performed on the image data.

Clause 73. The wireless communications device of any of clauses 71 to 72, wherein the means for determining the direction vectors comprises: means for determining azimuth and elevation angles of the set of NTN space vehicles with respect to the wireless communications device based on ephemeris data for the set of NTN space vehicles and a global navigation satellite system (GNSS) position fix of the wireless communications device; and means for determining the direction vectors based on the azimuth and elevation angles and an orientation of the at least one camera.

Clause 74. The wireless communications device of any of clauses 71 to 73, wherein the means for identifying the positions of the set of NTN space vehicles within the image data comprises: means for mapping the direction vectors to points in the image data using perspective projection based on parameters of the at least one camera.

Clause 75. The wireless communications device of any of clauses 71 to 74, wherein the means for determining that the positions of the subset of NTN space vehicles overlay the one or more obstructions comprises: means for determining that the positions of the subset of NTN space vehicles overlay the one or more obstructions by at least a threshold distance.

Clause 76. The wireless communications device of any of clauses 71 to 75, further comprising: means for prompting a user of the wireless communications device to capture the image data with the at least one camera of the wireless communications device.

Clause 77. The wireless communications device of any of clauses 67 to 76, wherein the means for determining that the one or more obstructions are blocking the subset of NTN space vehicles comprises: means for obtaining a crowdsourced obstruction table associated with the current location of the wireless communications device; and means for determining that the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 78. The wireless communications device of clause 77, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 79. The wireless communications device of clause 78, wherein the shape information for the one or more obstructions comprises: a subset of cells of the plurality of cells corresponding to the one or more obstructions, or sub-regions within cells of the plurality of cells corresponding to the one or more obstructions.

Clause 80. The wireless communications device of clause 79, wherein the sub-regions within the cells of the plurality of cells comprise azimuth and elevation regions with respect to a fixed reference direction for the one or more obstructions within the cells of the plurality of cells.

Clause 81. The wireless communications device of any of clauses 78 to 80, wherein a size of the plurality of cells is: means for fixing, or means for basing on an accuracy of the position fix of the wireless communications device.

Clause 82. The wireless communications device of any of clauses 77 to 81, wherein the crowdsourced obstruction table is obtained via: a terrestrial network, NTN connectivity, or any combination thereof.

Clause 83. The wireless communications device of any of clauses 77 to 82, wherein the one or more obstructions are determined to be blocking the subset of NTN space vehicles further based on direction vectors from the wireless communications device to the subset of NTN space vehicles.

Clause 84. The wireless communications device of any of clauses 77 to 83, further comprising: means for collecting one or more parameters associated with the subset of NTN space vehicles being blocked by the one or more obstructions; and means for reporting the one or more parameters to a terrestrial network server via terrestrial network connectivity or NTN connectivity.

Clause 85. The wireless communications device of clause 84, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 86. The wireless communications device of any of clauses 67 to 85, wherein the means for determining that the one or more obstructions are blocking the subset of NTN space vehicles comprises: means for detecting a set of GNSS space vehicles in view of the wireless communications device at the current location of the wireless communications device; means for identifying one or more azimuth and elevation regions that are not occupied by the set of GNSS space vehicles; and means for determining the one or more obstructions as the one or more azimuth and elevation regions.

Clause 87. The wireless communications device of any of clauses 67 to 86, wherein the wireless communications device is not connected to a terrestrial wireless communications network.

Clause 88. The wireless communications device of any of clauses 67 to 87, wherein the means for detecting the trigger comprises: means for receiving a request from a user or another component of the wireless communications device to communicate via NTN connectivity; means for detecting an emergency event at the wireless communications device; or any combination thereof.

Clause 89. The wireless communications device of any of clauses 67 to 88, wherein the means for attempting to communicate with the at least one space vehicle comprises: means for transmitting a message to the at least one NTN space vehicle.

Clause 90. A wireless communications device, comprising: means for detecting a trigger to communicate via non-terrestrial network (NTN) connectivity; means for determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; means for refraining from communicating with the one or more NTN space vehicles until at least one alignment opportunity of the one or more alignment opportunities; and means for attempting to communicate with at least one NTN space vehicle of the one or more NTN space vehicles during the at least one alignment opportunity of the one or more alignment opportunities.

Clause 91. The wireless communications device of clause 90, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 92. The wireless communications device of clause 91, wherein the transmission characteristics comprise an estimated transmit power, path loss, and antenna gain of the set of GNSS space vehicles.

Clause 93. The wireless communications device of any of clauses 91 to 92, wherein the antenna gain is determined based on: multiple measurements of the set of GNSS space vehicles, an empirical model of the antenna gain, a machine learning model of the antenna gain, or any combination thereof.

Clause 94. The wireless communications device of any of clauses 90 to 93, further comprising: means for determining that the one or more alignment opportunities will not occur within a threshold period of time of a current time; and means for prompting a user of the wireless communications device to reposition the wireless communications device.

Clause 95. The wireless communications device of any of clauses 90 to 94, wherein the means for refraining from communicating with the one or more NTN space vehicles comprises: means for transitioning to a sleep state until the at least one alignment opportunity of the one or more alignment opportunities.

Clause 96. The wireless communications device of any of clauses 90 to 95, further comprising: means for notifying a user of the wireless communications device of a time of a next alignment opportunity of the one or more alignment opportunities.

Clause 97. The wireless communications device of any of clauses 90 to 96, wherein the means for detecting the trigger comprises: means for receiving a request from a user or another component of the wireless communications device to communicate via NTN connectivity; means for detecting an emergency event at the wireless communications device; means for determining that the user is incapable of performing an interactive pointing procedure with the wireless communications device; or any combination thereof.

Clause 98. The wireless communications device of any of clauses 90 to 97, wherein the wireless communications device is not connected to a terrestrial wireless communications network.

Clause 99. The wireless communications device of any of clauses 90 to 98, wherein the means for attempting to communicate with the at least one space vehicle comprises: means for transmitting a message to the at least one NTN space vehicle.

Clause 100. A non-transitory computer-readable medium storing computer-executable instructions that, when executed by a wireless communications device, cause the wireless communications device to: detect a trigger to communicate via non-terrestrial network (NTN) connectivity; determine that one or more obstructions are blocking a subset of NTN space vehicles of a set of NTN space vehicles expected to be in view of the wireless communications device at a current location of the wireless communications device; and attempt to communicate with at least one NTN space vehicle of the set of NTN space vehicles other than the subset of NTN space vehicles.

Clause 101. The non-transitory computer-readable medium of clause 100, wherein the computer-executable instructions that, when executed by the wireless communications device, cause the wireless communications device to determine that the one or more obstructions are blocking the subset of NTN space vehicles comprise computer-executable instructions that, when executed by the wireless communications device, cause the wireless communications device to: identify the one or more obstructions on a map of a geographic area in which the wireless communications device is located; and determine that the one or more obstructions are within a threshold distance of the current location of the wireless communications device.

Clause 102. The non-transitory computer-readable medium of clause 101, wherein the computer-executable instructions that, when executed by the wireless communications device, cause the wireless communications device to determine that the one or more obstructions are blocking the subset of NTN space vehicles comprise computer-executable instructions that, when executed by the wireless communications device, cause the wireless communications device to: determine that the subset of NTN space vehicles is on an opposite side of or above the one or more obstructions from the wireless communications device.

Clause 103. The non-transitory computer-readable medium of any of clauses 101 to 102, wherein the map comprises: a two-dimensional (2D) map, a three-dimensional (3D) map, or a high-definition (HD) map.

Clause 104. The non-transitory computer-readable medium of any of clauses 100 to 103, wherein the computer-executable instructions that, when executed by the wireless communications device, cause the wireless communications device to determine that the one or more obstructions are blocking the subset of NTN space vehicles comprise computer-executable instructions that, when executed by the wireless communications device, cause the wireless communications device to: obtain image data from at least one camera of the wireless communications device; identify the one or more obstructions within the image data; determine direction vectors from the wireless communications device to the set of NTN space vehicles; identify positions of the set of NTN space vehicles within the image data based on the direction vectors; and determine that positions of the subset of NTN space vehicles overlay the one or more obstructions.

Clause 105. The non-transitory computer-readable medium of clause 104, wherein the one or more obstructions are identified within the image data based on object recognition performed on the image data.

Clause 106. The non-transitory computer-readable medium of any of clauses 104 to 105, wherein the computer-executable instructions that, when executed by the wireless communications device, cause the wireless communications device to determine the direction vectors comprise computer-executable instructions that, when executed by the wireless communications device, cause the wireless communications device to: determine azimuth and elevation angles of the set of NTN space vehicles with respect to the wireless communications device based on ephemeris data for the set of NTN space vehicles and a global navigation satellite system (GNSS) position fix of the wireless communications device; and determine the direction vectors based on the azimuth and elevation angles and an orientation of the at least one camera.

Clause 107. The non-transitory computer-readable medium of any of clauses 104 to 106, wherein the computer-executable instructions that, when executed by the wireless communications device, cause the wireless communications device to identify the positions of the set of NTN space vehicles within the image data comprise computer-executable instructions that, when executed by the wireless communications device, cause the wireless communications device to: map the direction vectors to points in the image data using perspective projection based on parameters of the at least one camera.

Clause 108. The non-transitory computer-readable medium of any of clauses 104 to 107, wherein the computer-executable instructions that, when executed by the wireless communications device, cause the wireless communications device to determine that the positions of the subset of NTN space vehicles overlay the one or more obstructions comprise computer-executable instructions that, when executed by the wireless communications device, cause the wireless communications device to: determine that the positions of the subset of NTN space vehicles overlay the one or more obstructions by at least a threshold distance.

Clause 109. The non-transitory computer-readable medium of any of clauses 104 to 108, further comprising computer-executable instructions that, when executed by the wireless communications device, cause the wireless communications device to: prompt a user of the wireless communications device to capture the image data with the at least one camera of the wireless communications device.

Clause 110. The non-transitory computer-readable medium of any of clauses 100 to 109, wherein the computer-executable instructions that, when executed by the wireless communications device, cause the wireless communications device to determine that the one or more obstructions are blocking the subset of NTN space vehicles comprise computer-executable instructions that, when executed by the wireless communications device, cause the wireless communications device to: obtain a crowdsourced obstruction table associated with the current location of the wireless communications device; and determine that the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 111. The non-transitory computer-readable medium of clause 110, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 112. The non-transitory computer-readable medium of clause 111, wherein the shape information for the one or more obstructions comprises: a subset of cells of the plurality of cells corresponding to the one or more obstructions, or sub-regions within cells of the plurality of cells corresponding to the one or more obstructions.

Clause 113. The non-transitory computer-readable medium of clause 112, wherein the sub-regions within the cells of the plurality of cells comprise azimuth and elevation regions with respect to a fixed reference direction for the one or more obstructions within the cells of the plurality of cells.

Clause 114. The non-transitory computer-readable medium of any of clauses 111 to 113, wherein a size of the plurality of cells is: fix, or base on an accuracy of the position fix of the wireless communications device.

Clause 115. The non-transitory computer-readable medium of any of clauses 110 to 114, wherein the crowdsourced obstruction table is obtained via: a terrestrial network, NTN connectivity, or any combination thereof.

Clause 116. The non-transitory computer-readable medium of any of clauses 110 to 115, wherein the one or more obstructions are determined to be blocking the subset of NTN space vehicles further based on direction vectors from the wireless communications device to the subset of NTN space vehicles.

Clause 117. The non-transitory computer-readable medium of any of clauses 110 to 116, further comprising computer-executable instructions that, when executed by the wireless communications device, cause the wireless communications device to: collect one or more parameters associated with the subset of NTN space vehicles being blocked by the one or more obstructions; and report the one or more parameters to a terrestrial network server via terrestrial network connectivity or NTN connectivity.

Clause 118. The non-transitory computer-readable medium of clause 117, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 119. The non-transitory computer-readable medium of any of clauses 100 to 118, wherein the computer-executable instructions that, when executed by the wireless communications device, cause the wireless communications device to determine that the one or more obstructions are blocking the subset of NTN space vehicles comprise computer-executable instructions that, when executed by the wireless communications device, cause the wireless communications device to: detect a set of GNSS space vehicles in view of the wireless communications device at the current location of the wireless communications device; identify one or more azimuth and elevation regions that are not occupied by the set of GNSS space vehicles; and determine the one or more obstructions as the one or more azimuth and elevation regions.

Clause 120. The non-transitory computer-readable medium of any of clauses 100 to 119, wherein the wireless communications device is not connected to a terrestrial wireless communications network.

Clause 121. The non-transitory computer-readable medium of any of clauses 100 to 120, wherein the computer-executable instructions that, when executed by the wireless communications device, cause the wireless communications device to detect the trigger comprise computer-executable instructions that, when executed by the wireless communications device, cause the wireless communications device to: receive a request from a user or another component of the wireless communications device to communicate via NTN connectivity; detect an emergency event at the wireless communications device; or any combination thereof.

Clause 122. The non-transitory computer-readable medium of any of clauses 100 to 121, wherein the computer-executable instructions that, when executed by the wireless communications device, cause the wireless communications device to attempt to communicate with the at least one space vehicle comprise computer-executable instructions that, when executed by the wireless communications device, cause the wireless communications device to: transmit a message to the at least one NTN space vehicle.

Clause 123. A non-transitory computer-readable medium storing computer-executable instructions that, when executed by a wireless communications device, cause the wireless communications device to: detect a trigger to communicate via non-terrestrial network (NTN) connectivity; determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; refrain from communicating with the one or more NTN space vehicles until at least one alignment opportunity of the one or more alignment opportunities; and attempt to communicate with at least one NTN space vehicle of the one or more NTN space vehicles during the at least one alignment opportunity of the one or more alignment opportunities.

Clause 124. The non-transitory computer-readable medium of clause 123, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 125. The non-transitory computer-readable medium of clause 124, wherein the transmission characteristics comprise an estimated transmit power, path loss, and antenna gain of the set of GNSS space vehicles.

Clause 126. The non-transitory computer-readable medium of any of clauses 124 to 125, wherein the antenna gain is determined based on: multiple measurements of the set of GNSS space vehicles, an empirical model of the antenna gain, a machine learning model of the antenna gain, or any combination thereof.

Clause 127. The non-transitory computer-readable medium of any of clauses 123 to 126, further comprising computer-executable instructions that, when executed by the wireless communications device, cause the wireless communications device to: determine that the one or more alignment opportunities will not occur within a threshold period of time of a current time; and prompt a user of the wireless communications device to reposition the wireless communications device.

Clause 128. The non-transitory computer-readable medium of any of clauses 123 to 127, wherein the computer-executable instructions that, when executed by the wireless communications device, cause the wireless communications device to refrain from communicating with the one or more NTN space vehicles comprise computer-executable instructions that, when executed by the wireless communications device, cause the wireless communications device to: transition to a sleep state until the at least one alignment opportunity of the one or more alignment opportunities.

Clause 129. The non-transitory computer-readable medium of any of clauses 123 to 128, further comprising computer-executable instructions that, when executed by the wireless communications device, cause the wireless communications device to: notify a user of the wireless communications device of a time of a next alignment opportunity of the one or more alignment opportunities.

Clause 130. The non-transitory computer-readable medium of any of clauses 123 to 129, wherein the computer-executable instructions that, when executed by the wireless communications device, cause the wireless communications device to detect the trigger comprise computer-executable instructions that, when executed by the wireless communications device, cause the wireless communications device to: receive a request from a user or another component of the wireless communications device to communicate via NTN connectivity; detect an emergency event at the wireless communications device; determine that the user is incapable of performing an interactive pointing procedure with the wireless communications device; or any combination thereof.

Clause 131. The non-transitory computer-readable medium of any of clauses 123 to 130, wherein the wireless communications device is not connected to a terrestrial wireless communications network.

Clause 132. The non-transitory computer-readable medium of any of clauses 123 to 131, wherein the computer-executable instructions that, when executed by the wireless communications device, cause the wireless communications device to attempt to communicate with the at least one space vehicle comprise computer-executable instructions that, when executed by the wireless communications device, cause the wireless communications device to: transmit a message to the at least one NTN space vehicle.

Additional implementation examples are described in the following numbered clauses: Clause 1. A method of wireless communication performed by a wireless communications device, comprising: detecting a trigger to communicate via non-terrestrial network (NTN) connectivity; determining whether one or more obstructions are estimated to be blocking a subset of NTN space vehicles of a set of NTN space vehicles expected to be in view of the wireless communications device at a current location of the wireless communications device; and transmitting, in response to a determination that the one or more obstructions are estimated to be blocking the subset of NTN space vehicles, at least one message towards at least one NTN space vehicle of the set of NTN space vehicles other than the subset of NTN space vehicles.

Clause 2. The method of clause 1, wherein determining whether the one or more obstructions are estimated to be blocking the subset of NTN space vehicles comprises: identifying the one or more obstructions on a map of a geographic area in which the wireless communications device is located; and determining whether the one or more obstructions are within a threshold distance of the current location of the wireless communications device.

Clause 3. The method of clause 2, wherein determining whether the one or more obstructions are estimated to be blocking the subset of NTN space vehicles comprises: determining whether the subset of NTN space vehicles is on an opposite side of or above the one or more obstructions from the wireless communications device.

Clause 4. The method of any of clauses 1 to 3, wherein determining whether the one or more obstructions are estimated to be blocking the subset of NTN space vehicles comprises: obtaining image data from at least one camera of the wireless communications device; identifying the one or more obstructions within the image data; determining direction vectors from the wireless communications device to the set of NTN space vehicles; identifying positions of the set of NTN space vehicles within the image data based on the direction vectors; and determining whether positions of the subset of NTN space vehicles overlay the one or more obstructions.

Clause 5. The method of clause 4, wherein determining the direction vectors comprises: determining azimuth and elevation angles of the set of NTN space vehicles with respect to the wireless communications device based on ephemeris data for the set of NTN space vehicles and a global navigation satellite system (GNSS) position fix of the wireless communications device; and determining the direction vectors based on the azimuth and elevation angles and an orientation of the at least one camera.

Clause 6. The method of any of clauses 4 to 5, wherein identifying the positions of the set of NTN space vehicles within the image data comprises: mapping the direction vectors to points in the image data using perspective projection based on parameters of the at least one camera.

Clause 7. The method of any of clauses 4 to 6, wherein determining whether the positions of the subset of NTN space vehicles overlay the one or more obstructions comprises: determining whether the positions of the subset of NTN space vehicles overlay the one or more obstructions by at least a threshold distance.

Clause 8. The method of any of clauses 4 to 7, further comprising: prompting a user of the wireless communications device to capture the image data with the at least one camera of the wireless communications device.

Clause 9. The method of any of clauses 1 to 8, wherein determining whether the one or more obstructions are blocking the subset of NTN space vehicles comprises: obtaining a crowdsourced obstruction table associated with the current location of the wireless communications device; and determining whether the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 10. The method of clause 9, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 11. The method of clause 10, wherein the shape information for the one or more obstructions comprises: a subset of cells of the plurality of cells corresponding to the one or more obstructions, or sub-regions within cells of the plurality of cells corresponding to the one or more obstructions.

Clause 12. The method of clause 11, wherein the sub-regions within the cells of the plurality of cells comprise azimuth and elevation regions with respect to a fixed reference direction for the one or more obstructions within the cells of the plurality of cells.

Clause 13. The method of any of clauses 10 to 12, wherein a size of the plurality of cells is: fixed, or based on an accuracy of the position fix of the wireless communications device.

Clause 14. The method of any of clauses 9 to 13, wherein the crowdsourced obstruction table is obtained via: a terrestrial network, or NTN connectivity, or any combination thereof.

Clause 15. The method of any of clauses 9 to 14, wherein the one or more obstructions are determined to be blocking the subset of NTN space vehicles based on direction vectors from the wireless communications device to the subset of NTN space vehicles.

Clause 16. The method of any of clauses 9 to 15, further comprising: collecting one or more parameters associated with the subset of NTN space vehicles being blocked by the one or more obstructions; and reporting the one or more parameters to a terrestrial network server via terrestrial network connectivity or NTN connectivity.

Clause 17. The method of clause 16, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 18. The method of any of clauses 1 to 17, wherein determining whether the one or more obstructions are blocking the subset of NTN space vehicles comprises: detecting a set of GNSS space vehicles in view of the wireless communications device at the current location of the wireless communications device; identifying one or more azimuth and elevation regions that are not occupied by the set of GNSS space vehicles; and determining the one or more obstructions as the one or more azimuth and elevation regions.

Clause 19. The method of any of clauses 1 to 18, wherein detecting the trigger comprises: receiving a request from a user or another component of the wireless communications device to communicate via NTN connectivity; detecting an emergency event at the wireless communications device; or any combination thereof.

Clause 20. A method of wireless communication performed by a wireless communications device, comprising: detecting a trigger to communicate via non-terrestrial network (NTN) connectivity; determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and transmitting at least one message towards at least one NTN space vehicle of the one or more NTN space vehicles during at least one alignment opportunity of the one or more alignment opportunities.

Clause 21. The method of clause 20, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 22. The method of clause 21, wherein the transmission characteristics comprise an estimated transmit power, path loss, and antenna gain of the set of GNSS space vehicles.

Clause 23. The method of clause 22, wherein the antenna gain is determined based on: multiple measurements of the set of GNSS space vehicles, an empirical model of the antenna gain, a machine learning model of the antenna gain, or any combination thereof.

Clause 24. The method of any of clauses 20 to 23, further comprising: determining that the one or more alignment opportunities will not occur within a threshold period of time of a current time; and prompting a user of the wireless communications device to reposition the wireless communications device.

Clause 25. The method of any of clauses 20 to 24, further comprising: transitioning to a sleep state until the at least one alignment opportunity of the one or more alignment opportunities.

Clause 26. The method of any of clauses 20 to 25, further comprising: notifying a user of the wireless communications device of a time of a next alignment opportunity of the one or more alignment opportunities.

Clause 27. The method of any of clauses 20 to 26, wherein detecting the trigger comprises: receiving a request from a user or another component of the wireless communications device to communicate via NTN connectivity; detecting an emergency event at the wireless communications device; determining that the user is incapable of performing an interactive pointing procedure with the wireless communications device; or any combination thereof.

Clause 28. A wireless communications device, comprising: one or more memories; one or more transceivers; and one or more processors communicatively coupled to the one or more memories and the one or more transceivers, the one or more processors, either alone or in combination, configured to: detect a trigger to communicate via non-terrestrial network (NTN) connectivity; determine whether one or more obstructions are estimated to be blocking a subset of NTN space vehicles of a set of NTN space vehicles expected to be in view of the wireless communications device at a current location of the wireless communications device; and transmit, via the one or more transceivers, in response to a determination that the one or more obstructions are estimated to be blocking the subset of NTN space vehicles, at least one message towards at least one NTN space vehicle of the set of NTN space vehicles other than the subset of NTN space vehicles.

Clause 29. The wireless communications device of clause 28, wherein the one or more processors configured to determine whether the one or more obstructions are estimated to be blocking the subset of NTN space vehicles comprises the one or more processors, either alone or in combination, configured to: identify the one or more obstructions on a map of a geographic area in which the wireless communications device is located; and determine whether the one or more obstructions are within a threshold distance of the current location of the wireless communications device.

Clause 30. The wireless communications device of clause 29, wherein the one or more processors configured to determine whether the one or more obstructions are estimated to be blocking the subset of NTN space vehicles comprises the one or more processors, either alone or in combination, configured to: determine whether the subset of NTN space vehicles is on an opposite side of or above the one or more obstructions from the wireless communications device.

Clause 31. The wireless communications device of any of clauses 28 to 30, wherein the one or more processors configured to determine whether the one or more obstructions are estimated to be blocking the subset of NTN space vehicles comprises the one or more processors, either alone or in combination, configured to: obtain image data from at least one camera of the wireless communications device; identify the one or more obstructions within the image data; determine direction vectors from the wireless communications device to the set of NTN space vehicles; identify positions of the set of NTN space vehicles within the image data based on the direction vectors; and determine whether positions of the subset of NTN space vehicles overlay the one or more obstructions.

Clause 32. The wireless communications device of clause 31, wherein the one or more processors configured to determine the direction vectors comprises the one or more processors, either alone or in combination, configured to: determine azimuth and elevation angles of the set of NTN space vehicles with respect to the wireless communications device based on ephemeris data for the set of NTN space vehicles and a global navigation satellite system (GNSS) position fix of the wireless communications device; and determine the direction vectors based on the azimuth and elevation angles and an orientation of the at least one camera.

Clause 33. The wireless communications device of any of clauses 31 to 32, wherein the one or more processors configured to identify the positions of the set of NTN space vehicles within the image data comprises the one or more processors, either alone or in combination, configured to: map the direction vectors to points in the image data using perspective projection based on parameters of the at least one camera.

Clause 34. The wireless communications device of any of clauses 31 to 33, wherein the one or more processors configured to determine whether the positions of the subset of NTN space vehicles overlay the one or more obstructions comprises the one or more processors, either alone or in combination, configured to: determine whether the positions of the subset of NTN space vehicles overlay the one or more obstructions by at least a threshold distance.

Clause 35. The wireless communications device of any of clauses 31 to 34, wherein the one or more processors, either alone or in combination, are further configured to: prompt a user of the wireless communications device to capture the image data with the at least one camera of the wireless communications device.

Clause 36. The wireless communications device of any of clauses 28 to 35, wherein the one or more processors configured to determine whether the one or more obstructions are blocking the subset of NTN space vehicles comprises the one or more processors, either alone or in combination, configured to: obtain a crowdsourced obstruction table associated with the current location of the wireless communications device; and determine whether the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 37. The wireless communications device of clause 36, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 38. The wireless communications device of clause 37, wherein the shape information for the one or more obstructions comprises: a subset of cells of the plurality of cells corresponding to the one or more obstructions, or sub-regions within cells of the plurality of cells corresponding to the one or more obstructions.

Clause 39. The wireless communications device of clause 38, wherein the sub-regions within the cells of the plurality of cells comprise azimuth and elevation regions with respect to a fixed reference direction for the one or more obstructions within the cells of the plurality of cells.

Clause 40. The wireless communications device of any of clauses 37 to 39, wherein a size of the plurality of cells is: fixed, or based on an accuracy of the position fix of the wireless communications device.

Clause 41. The wireless communications device of any of clauses 36 to 40, wherein the crowdsourced obstruction table is obtained via: a terrestrial network, or NTN connectivity, or any combination thereof.

Clause 42. The wireless communications device of any of clauses 36 to 41, wherein the one or more obstructions are determined to be blocking the subset of NTN space vehicles based on direction vectors from the wireless communications device to the subset of NTN space vehicles.

Clause 43. The wireless communications device of any of clauses 36 to 42, wherein the one or more processors, either alone or in combination, are further configured to: collect one or more parameters associated with the subset of NTN space vehicles being blocked by the one or more obstructions; and report, via the one or more transceivers, the one or more parameters to a terrestrial network server via terrestrial network connectivity or NTN connectivity.

Clause 44. The wireless communications device of clause 43, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 45. The wireless communications device of any of clauses 28 to 44, wherein the one or more processors configured to determine whether the one or more obstructions are blocking the subset of NTN space vehicles comprises the one or more processors, either alone or in combination, configured to: detect a set of GNSS space vehicles in view of the wireless communications device at the current location of the wireless communications device; identify one or more azimuth and elevation regions that are not occupied by the set of GNSS space vehicles; and determine the one or more obstructions as the one or more azimuth and elevation regions.

Clause 46. The wireless communications device of any of clauses 28 to 45, wherein the one or more processors configured to detect the trigger comprises the one or more processors, either alone or in combination, configured to: receive, via the one or more transceivers, a request from a user or another component of the wireless communications device to communicate via NTN connectivity; detect an emergency event at the wireless communications device; or any combination thereof.

Clause 47. A wireless communications device, comprising: one or more memories; one or more transceivers; and one or more processors communicatively coupled to the one or more memories and the one or more transceivers, the one or more processors, either alone or in combination, configured to: detect a trigger to communicate via non-terrestrial network (NTN) connectivity; determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and transmit, via the one or more transceivers, at least one message towards at least one NTN space vehicle of the one or more NTN space vehicles during at least one alignment opportunity of the one or more alignment opportunities.

Clause 48. The wireless communications device of clause 47, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 49. The wireless communications device of clause 48, wherein the transmission characteristics comprise an estimated transmit power, path loss, and antenna gain of the set of GNSS space vehicles.

Clause 50. The wireless communications device of clause 49, wherein the antenna gain is determined based on: multiple measurements of the set of GNSS space vehicles, an empirical model of the antenna gain, a machine learning model of the antenna gain, or any combination thereof.

Clause 51. The wireless communications device of any of clauses 47 to 50, wherein the one or more processors, either alone or in combination, are further configured to: determine that the one or more alignment opportunities will not occur within a threshold period of time of a current time; and prompt a user of the wireless communications device to reposition the wireless communications device.

Clause 52. The wireless communications device of any of clauses 47 to 51, wherein the one or more processors, either alone or in combination, are further configured to: transition to a sleep state until the at least one alignment opportunity of the one or more alignment opportunities.

Clause 53. The wireless communications device of any of clauses 47 to 52, wherein the one or more processors, either alone or in combination, are further configured to: notify a user of the wireless communications device of a time of a next alignment opportunity of the one or more alignment opportunities.

Clause 54. The wireless communications device of any of clauses 47 to 53, wherein the one or more processors configured to detect the trigger comprises the one or more processors, either alone or in combination, configured to: receive, via the one or more transceivers, a request from a user or another component of the wireless communications device to communicate via NTN connectivity; detect an emergency event at the wireless communications device; determine that the user is incapable of performing an interactive pointing procedure with the wireless communications device; or any combination thereof.

Clause 55. A wireless communications device, comprising: means for detecting a trigger to communicate via non-terrestrial network (NTN) connectivity; means for determining whether one or more obstructions are estimated to be blocking a subset of NTN space vehicles of a set of NTN space vehicles expected to be in view of the wireless communications device at a current location of the wireless communications device; and means for transmitting, in response to a determination that the one or more obstructions are estimated to be blocking the subset of NTN space vehicles, at least one message towards at least one NTN space vehicle of the set of NTN space vehicles other than the subset of NTN space vehicles.

Clause 56. The wireless communications device of clause 55, wherein the means for determining whether the one or more obstructions are estimated to be blocking the subset of NTN space vehicles comprises: means for identifying the one or more obstructions on a map of a geographic area in which the wireless communications device is located; and means for determining whether the one or more obstructions are within a threshold distance of the current location of the wireless communications device.

Clause 57. The wireless communications device of clause 56, wherein the means for determining whether the one or more obstructions are estimated to be blocking the subset of NTN space vehicles comprises: means for determining whether the subset of NTN space vehicles is on an opposite side of or above the one or more obstructions from the wireless communications device.

Clause 58. The wireless communications device of any of clauses 55 to 57, wherein the means for determining whether the one or more obstructions are estimated to be blocking the subset of NTN space vehicles comprises: means for obtaining image data from at least one camera of the wireless communications device; means for identifying the one or more obstructions within the image data; means for determining direction vectors from the wireless communications device to the set of NTN space vehicles; means for identifying positions of the set of NTN space vehicles within the image data based on the direction vectors; and means for determining whether positions of the subset of NTN space vehicles overlay the one or more obstructions.

Clause 59. The wireless communications device of clause 58, wherein the means for determining the direction vectors comprises: means for determining azimuth and elevation angles of the set of NTN space vehicles with respect to the wireless communications device based on ephemeris data for the set of NTN space vehicles and a global navigation satellite system (GNSS) position fix of the wireless communications device; and means for determining the direction vectors based on the azimuth and elevation angles and an orientation of the at least one camera.

Clause 60. The wireless communications device of any of clauses 58 to 59, wherein the means for identifying the positions of the set of NTN space vehicles within the image data comprises: means for mapping the direction vectors to points in the image data using perspective projection based on parameters of the at least one camera.

Clause 61. The wireless communications device of any of clauses 58 to 60, wherein the means for determining whether the positions of the subset of NTN space vehicles overlay the one or more obstructions comprises: means for determining whether the positions of the subset of NTN space vehicles overlay the one or more obstructions by at least a threshold distance.

Clause 62. The wireless communications device of any of clauses 58 to 61, further comprising: means for prompting a user of the wireless communications device to capture the image data with the at least one camera of the wireless communications device.

Clause 63. The wireless communications device of any of clauses 55 to 62, wherein the means for determining whether the one or more obstructions are blocking the subset of NTN space vehicles comprises: means for obtaining a crowdsourced obstruction table associated with the current location of the wireless communications device; and means for determining whether the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 64. The wireless communications device of clause 63, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 65. The wireless communications device of clause 64, wherein the shape information for the one or more obstructions comprises: a subset of cells of the plurality of cells corresponding to the one or more obstructions, or sub-regions within cells of the plurality of cells corresponding to the one or more obstructions.

Clause 66. The wireless communications device of clause 65, wherein the sub-regions within the cells of the plurality of cells comprise azimuth and elevation regions with respect to a fixed reference direction for the one or more obstructions within the cells of the plurality of cells.

Clause 67. The wireless communications device of any of clauses 64 to 66, wherein a size of the plurality of cells is: fixed, or based on an accuracy of the position fix of the wireless communications device.

Clause 68. The wireless communications device of any of clauses 63 to 67, wherein the crowdsourced obstruction table is obtained via: a terrestrial network, or NTN connectivity, or any combination thereof.

Clause 69. The wireless communications device of any of clauses 63 to 68, wherein the one or more obstructions are determined to be blocking the subset of NTN space vehicles based on direction vectors from the wireless communications device to the subset of NTN space vehicles.

Clause 70. The wireless communications device of any of clauses 63 to 69, further comprising: means for collecting one or more parameters associated with the subset of NTN space vehicles being blocked by the one or more obstructions; and means for reporting the one or more parameters to a terrestrial network server via terrestrial network connectivity or NTN connectivity.

Clause 71. The wireless communications device of clause 70, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 72. The wireless communications device of any of clauses 55 to 71, wherein the means for determining whether the one or more obstructions are blocking the subset of NTN space vehicles comprises: means for detecting a set of GNSS space vehicles in view of the wireless communications device at the current location of the wireless communications device; means for identifying one or more azimuth and elevation regions that are not occupied by the set of GNSS space vehicles; and means for determining the one or more obstructions as the one or more azimuth and elevation regions.

Clause 73. The wireless communications device of any of clauses 55 to 72, wherein the means for detecting the trigger comprises: means for receiving a request from a user or another component of the wireless communications device to communicate via NTN connectivity; means for detecting an emergency event at the wireless communications device; or any combination thereof.

Clause 74. A wireless communications device, comprising: means for detecting a trigger to communicate via non-terrestrial network (NTN) connectivity; means for determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and means for transmitting at least one message towards at least one NTN space vehicle of the one or more NTN space vehicles during at least one alignment opportunity of the one or more alignment opportunities.

Clause 75. The wireless communications device of clause 74, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 76. The wireless communications device of clause 75, wherein the transmission characteristics comprise an estimated transmit power, path loss, and antenna gain of the set of GNSS space vehicles.

Clause 77. The wireless communications device of clause 76, wherein the antenna gain is determined based on: multiple measurements of the set of GNSS space vehicles, an empirical model of the antenna gain, a machine learning model of the antenna gain, or any combination thereof.

Clause 78. The wireless communications device of any of clauses 74 to 77, further comprising: means for determining that the one or more alignment opportunities will not occur within a threshold period of time of a current time; and means for prompting a user of the wireless communications device to reposition the wireless communications device.

Clause 79. The wireless communications device of any of clauses 74 to 78, further comprising: means for transitioning to a sleep state until the at least one alignment opportunity of the one or more alignment opportunities.

Clause 80. The wireless communications device of any of clauses 74 to 79, further comprising: means for notifying a user of the wireless communications device of a time of a next alignment opportunity of the one or more alignment opportunities.

Clause 81. The wireless communications device of any of clauses 74 to 80, wherein the means for detecting the trigger comprises: means for receiving a request from a user or another component of the wireless communications device to communicate via NTN connectivity; means for detecting an emergency event at the wireless communications device; means for determining that the user is incapable of performing an interactive pointing procedure with the wireless communications device; or any combination thereof.

Clause 82. A non-transitory computer-readable medium storing computer-executable instructions that, when executed by a wireless communications device, cause the wireless communications device to: detect a trigger to communicate via non-terrestrial network (NTN) connectivity; determine whether one or more obstructions are estimated to be blocking a subset of NTN space vehicles of a set of NTN space vehicles expected to be in view of the wireless communications device at a current location of the wireless communications device; and transmit, in response to a determination that the one or more obstructions are estimated to be blocking the subset of NTN space vehicles, at least one message towards at least one NTN space vehicle of the set of NTN space vehicles other than the subset of NTN space vehicles.

Clause 83. The non-transitory computer-readable medium of clause 82, wherein the computer-executable instructions that, when executed by the wireless communications device, cause the wireless communications device to determine whether the one or more obstructions are estimated to be blocking the subset of NTN space vehicles comprise computer-executable instructions that, when executed by the wireless communications device, cause the wireless communications device to: identify the one or more obstructions on a map of a geographic area in which the wireless communications device is located; and determine whether the one or more obstructions are within a threshold distance of the current location of the wireless communications device.

Clause 84. The non-transitory computer-readable medium of clause 83, wherein the computer-executable instructions that, when executed by the wireless communications device, cause the wireless communications device to determine whether the one or more obstructions are estimated to be blocking the subset of NTN space vehicles comprise computer-executable instructions that, when executed by the wireless communications device, cause the wireless communications device to: determine whether the subset of NTN space vehicles is on an opposite side of or above the one or more obstructions from the wireless communications device.

Clause 85. The non-transitory computer-readable medium of any of clauses 82 to 84, wherein the computer-executable instructions that, when executed by the wireless communications device, cause the wireless communications device to determine whether the one or more obstructions are estimated to be blocking the subset of NTN space vehicles comprise computer-executable instructions that, when executed by the wireless communications device, cause the wireless communications device to: obtain image data from at least one camera of the wireless communications device; identify the one or more obstructions within the image data; determine direction vectors from the wireless communications device to the set of NTN space vehicles; identify positions of the set of NTN space vehicles within the image data based on the direction vectors; and determine whether positions of the subset of NTN space vehicles overlay the one or more obstructions.

Clause 86. The non-transitory computer-readable medium of clause 85, wherein the computer-executable instructions that, when executed by the wireless communications device, cause the wireless communications device to determine the direction vectors comprise computer-executable instructions that, when executed by the wireless communications device, cause the wireless communications device to: determine azimuth and elevation angles of the set of NTN space vehicles with respect to the wireless communications device based on ephemeris data for the set of NTN space vehicles and a global navigation satellite system (GNSS) position fix of the wireless communications device; and determine the direction vectors based on the azimuth and elevation angles and an orientation of the at least one camera.

Clause 87. The non-transitory computer-readable medium of any of clauses 85 to 86, wherein the computer-executable instructions that, when executed by the wireless communications device, cause the wireless communications device to identify the positions of the set of NTN space vehicles within the image data comprise computer-executable instructions that, when executed by the wireless communications device, cause the wireless communications device to: map the direction vectors to points in the image data using perspective projection based on parameters of the at least one camera.

Clause 88. The non-transitory computer-readable medium of any of clauses 85 to 87, wherein the computer-executable instructions that, when executed by the wireless communications device, cause the wireless communications device to determine whether the positions of the subset of NTN space vehicles overlay the one or more obstructions comprise computer-executable instructions that, when executed by the wireless communications device, cause the wireless communications device to: determine whether the positions of the subset of NTN space vehicles overlay the one or more obstructions by at least a threshold distance.

Clause 89. The non-transitory computer-readable medium of any of clauses 85 to 88, further comprising computer-executable instructions that, when executed by the wireless communications device, cause the wireless communications device to: prompt a user of the wireless communications device to capture the image data with the at least one camera of the wireless communications device.

Clause 90. The non-transitory computer-readable medium of any of clauses 82 to 89, wherein the computer-executable instructions that, when executed by the wireless communications device, cause the wireless communications device to determine whether the one or more obstructions are blocking the subset of NTN space vehicles comprise computer-executable instructions that, when executed by the wireless communications device, cause the wireless communications device to: obtain a crowdsourced obstruction table associated with the current location of the wireless communications device; and determine whether the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

Clause 91. The non-transitory computer-readable medium of clause 90, wherein: the crowdsourced obstruction table comprises a plurality of cells of a grid, and the information defining the one or more obstructions in the crowdsourced obstruction table comprises shape information for the one or more obstructions, an azimuth and elevation direction relative to a fixed direction, or both.

Clause 92. The non-transitory computer-readable medium of clause 91, wherein the shape information for the one or more obstructions comprises: a subset of cells of the plurality of cells corresponding to the one or more obstructions, or sub-regions within cells of the plurality of cells corresponding to the one or more obstructions.

Clause 93. The non-transitory computer-readable medium of clause 92, wherein the sub-regions within the cells of the plurality of cells comprise azimuth and elevation regions with respect to a fixed reference direction for the one or more obstructions within the cells of the plurality of cells.

Clause 94. The non-transitory computer-readable medium of any of clauses 91 to 93, wherein a size of the plurality of cells is: fixed, or based on an accuracy of the position fix of the wireless communications device.

Clause 95. The non-transitory computer-readable medium of any of clauses 90 to 94, wherein the crowdsourced obstruction table is obtained via: a terrestrial network, or NTN connectivity, or any combination thereof.

Clause 96. The non-transitory computer-readable medium of any of clauses 90 to 95, wherein the one or more obstructions are determined to be blocking the subset of NTN space vehicles based on direction vectors from the wireless communications device to the subset of NTN space vehicles.

Clause 97. The non-transitory computer-readable medium of any of clauses 90 to 96, further comprising computer-executable instructions that, when executed by the wireless communications device, cause the wireless communications device to: collect one or more parameters associated with the subset of NTN space vehicles being blocked by the one or more obstructions; and report the one or more parameters to a terrestrial network server via terrestrial network connectivity or NTN connectivity.

Clause 98. The non-transitory computer-readable medium of clause 97, wherein the one or more parameters comprise: a GNSS position fix of the wireless communications device at the current location of the wireless communications device, an orientation of the wireless communications device, an orientation, alignment, or both of the one or more antennas of the wireless communications device, the radiation patterns of the one or more antennas of the wireless communication device, direction vectors from the wireless communications device to the subset of NTN space vehicles, the altitude of the wireless communications device, a direction of True North relative to the wireless communications device, a timestamp of a failure of the wireless communications device to obtain NTN connectivity, a failure signal associated with the failure, a failure type associated with the failure, a failure rate associated with the failure, signal strength, a frequency offset, a unique identification number of the wireless communications device, unique identifiers of the subset of NTN space vehicles, identifiers associated with the subset of NTN space vehicles, one or more beam identifiers associated with the subset of NTN space vehicles, one or more cell identifiers associated with one or more beams of the subset of NTN space vehicles, public land mobile network (PLMN) identifiers associated with the subset of NTN space vehicles, an expected doppler frequency associated with the subset of NTN space vehicles, carrier frequency information associated with the subset of NTN space vehicles, or any combination thereof.

Clause 99. The non-transitory computer-readable medium of any of clauses 82 to 98, wherein the computer-executable instructions that, when executed by the wireless communications device, cause the wireless communications device to determine whether the one or more obstructions are blocking the subset of NTN space vehicles comprise computer-executable instructions that, when executed by the wireless communications device, cause the wireless communications device to: detect a set of GNSS space vehicles in view of the wireless communications device at the current location of the wireless communications device; identify one or more azimuth and elevation regions that are not occupied by the set of GNSS space vehicles; and determine the one or more obstructions as the one or more azimuth and elevation regions.

Clause 100. The non-transitory computer-readable medium of any of clauses 82 to 99, wherein the computer-executable instructions that, when executed by the wireless communications device, cause the wireless communications device to detect the trigger comprise computer-executable instructions that, when executed by the wireless communications device, cause the wireless communications device to: receive a request from a user or another component of the wireless communications device to communicate via NTN connectivity; detect an emergency event at the wireless communications device; or any combination thereof.

Clause 101. A non-transitory computer-readable medium storing computer-executable instructions that, when executed by a wireless communications device, cause the wireless communications device to: detect a trigger to communicate via non-terrestrial network (NTN) connectivity; determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and transmit at least one message towards at least one NTN space vehicle of the one or more NTN space vehicles during at least one alignment opportunity of the one or more alignment opportunities.

Clause 102. The non-transitory computer-readable medium of clause 101, wherein the one or more alignment opportunities are determined based on: transmission characteristics of a set of global navigation satellite system (GNSS) space vehicles in view of the wireless communications device at a current location of the wireless communications device, and orbit information of the one or more NTN space vehicles.

Clause 103. The non-transitory computer-readable medium of clause 102, wherein the transmission characteristics comprise an estimated transmit power, path loss, and antenna gain of the set of GNSS space vehicles.

Clause 104. The non-transitory computer-readable medium of clause 103, wherein the antenna gain is determined based on: multiple measurements of the set of GNSS space vehicles, an empirical model of the antenna gain, a machine learning model of the antenna gain, or any combination thereof.

Clause 105. The non-transitory computer-readable medium of any of clauses 101 to 104, further comprising computer-executable instructions that, when executed by the wireless communications device, cause the wireless communications device to: determine that the one or more alignment opportunities will not occur within a threshold period of time of a current time; and prompt a user of the wireless communications device to reposition the wireless communications device.

Clause 106. The non-transitory computer-readable medium of any of clauses 101 to 105, further comprising computer-executable instructions that, when executed by the wireless communications device, cause the wireless communications device to: transition to a sleep state until the at least one alignment opportunity of the one or more alignment opportunities.

Clause 107. The non-transitory computer-readable medium of any of clauses 101 to 106, further comprising computer-executable instructions that, when executed by the wireless communications device, cause the wireless communications device to: notify a user of the wireless communications device of a time of a next alignment opportunity of the one or more alignment opportunities.

Clause 108. The non-transitory computer-readable medium of any of clauses 101 to 107, wherein the computer-executable instructions that, when executed by the wireless communications device, cause the wireless communications device to detect the trigger comprise computer-executable instructions that, when executed by the wireless communications device, cause the wireless communications device to: receive a request from a user or another component of the wireless communications device to communicate via NTN connectivity; detect an emergency event at the wireless communications device; determine that the user is incapable of performing an interactive pointing procedure with the wireless communications device; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a wireless communications device, comprising:
detecting a trigger to communicate via non-terrestrial network (NTN) connectivity;
determining whether one or more obstructions are estimated to be blocking a subset of NTN space vehicles of a set of NTN space vehicles expected to be in view of the wireless communications device at a current location of the wireless communications device; and
transmitting, in response to a determination that the one or more obstructions are estimated to be blocking the subset of NTN space vehicles, at least one message towards at least one NTN space vehicle of the set of NTN space vehicles other than the subset of NTN space vehicles.

2. The method of claim 1, wherein determining whether the one or more obstructions are estimated to be blocking the subset of NTN space vehicles comprises:
identifying the one or more obstructions on a map of a geographic area in which the wireless communications device is located; and
determining whether the one or more obstructions are within a threshold distance of the current location of the wireless communications device.

3. The method of claim 2, wherein determining whether the one or more obstructions are estimated to be blocking the subset of NTN space vehicles comprises:
determining whether the subset of NTN space vehicles is on an opposite side of or above the one or more obstructions from the wireless communications device.

4. The method of claim 1, wherein determining whether the one or more obstructions are estimated to be blocking the subset of NTN space vehicles comprises:
obtaining image data from at least one camera of the wireless communications device;
identifying the one or more obstructions within the image data;
determining direction vectors from the wireless communications device to the set of NTN space vehicles;
identifying positions of the set of NTN space vehicles within the image data based on the direction vectors; and
determining whether positions of the subset of NTN space vehicles overlay the one or more obstructions.

5. The method of claim 4, wherein determining the direction vectors comprises:
determining azimuth and elevation angles of the set of NTN space vehicles with respect to the wireless communications device based on ephemeris data for the set of NTN space vehicles and a global navigation satellite system (GNSS) position fix of the wireless communications device; and
determining the direction vectors based on the azimuth and elevation angles and an orientation of the at least one camera.

6. The method of claim 4, wherein identifying the positions of the set of NTN space vehicles within the image data comprises:
mapping the direction vectors to points in the image data using perspective projection based on parameters of the at least one camera.

7. The method of claim 4, wherein determining whether the positions of the subset of NTN space vehicles overlay the one or more obstructions comprises:
determining whether the positions of the subset of NTN space vehicles overlay the one or more obstructions by at least a threshold distance.

8. The method of claim 4, further comprising:
prompting a user of the wireless communications device to capture the image data with the at least one camera of the wireless communications device.

9. The method of claim 1, wherein determining whether the one or more obstructions are blocking the subset of NTN space vehicles comprises:
obtaining a crowdsourced obstruction table associated with the current location of the wireless communications device; and
determining whether the one or more obstructions are blocking the subset of NTN space vehicles based on information defining the one or more obstructions in the crowdsourced obstruction table, a position fix of the wireless communications device, an altitude of the wireless communications device, radiation patterns of one or more antennas of the wireless communication device, and an orientation of the wireless communications device.

10. The method of claim 9, wherein:
the crowdsourced obstruction table comprises a plurality of cells of a grid, and
the information defining the one or more obstructions in the crowdsourced obstruction table comprises shape information for the one or more obstructions, an azimuth and elevation direction relative to a fixed direction, or both.

11. The method of claim 10, wherein the shape information for the one or more obstructions comprises:
a subset of cells of the plurality of cells corresponding to the one or more obstructions, or
sub-regions within cells of the plurality of cells corresponding to the one or more obstructions.

12. The method of claim 11, wherein the sub-regions within the cells of the plurality of cells comprise azimuth and elevation regions with respect to a fixed reference direction for the one or more obstructions within the cells of the plurality of cells.

13. The method of claim 10, wherein a size of the plurality of cells is:
fixed, or
based on an accuracy of the position fix of the wireless communications device.

14. The method of claim 9, wherein the crowdsourced obstruction table is obtained via:
a terrestrial network, or
NTN connectivity, or
any combination thereof.

15. The method of claim 9, wherein the one or more obstructions are determined to be blocking the subset of NTN space vehicles based on direction vectors from the wireless communications device to the subset of NTN space vehicles.

16. The method of claim 9, further comprising:
collecting one or more parameters associated with the subset of NTN space vehicles being blocked by the one or more obstructions; and
reporting the one or more parameters to a terrestrial network server via terrestrial network connectivity or NTN connectivity.

17. The method of claim 16, wherein the one or more parameters comprise:
a GNSS position fix of the wireless communications device at the current location of the wireless communications device,
an orientation of the wireless communications device,
an orientation, alignment, or both of the one or more antennas of the wireless communications device,
the radiation patterns of the one or more antennas of the wireless communication device,
direction vectors from the wireless communications device to the subset of NTN space vehicles,
the altitude of the wireless communications device,
a direction of True North relative to the wireless communications device,
a timestamp of a failure of the wireless communications device to obtain NTN connectivity,
a failure signal associated with the failure,
a failure type associated with the failure,
a failure rate associated with the failure,
signal strength,
a frequency offset,
a unique identification number of the wireless communications device, unique identifiers of the subset of NTN space vehicles,
identifiers associated with the subset of NTN space vehicles,
one or more beam identifiers associated with the subset of NTN space vehicles,
one or more cell identifiers associated with one or more beams of the subset of NTN space vehicles,
public land mobile network (PLMN) identifiers associated with the subset of NTN space vehicles,
an expected doppler frequency associated with the subset of NTN space vehicles,
carrier frequency information associated with the subset of NTN space vehicles, or
any combination thereof.

18. The method of claim 1, wherein determining whether the one or more obstructions are blocking the subset of NTN space vehicles comprises:
detecting a set of GNSS space vehicles in view of the wireless communications device at the current location of the wireless communications device;
identifying one or more azimuth and elevation regions that are not occupied by the set of GNSS space vehicles; and
determining the one or more obstructions as the one or more azimuth and elevation regions.

19. The method of claim 1, wherein detecting the trigger comprises:
receiving a request from a user or another component of the wireless communications device to communicate via NTN connectivity;
detecting an emergency event at the wireless communications device; or
any combination thereof.

20. A method of wireless communication performed by a wireless communications device, comprising:
detecting a trigger to communicate via non-terrestrial network (NTN) connectivity;
determining one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and
transmitting at least one message towards at least one NTN space vehicle of the one or more NTN space vehicles during at least one alignment opportunity of the one or more alignment opportunities.

21. The method of claim 20, wherein the one or more alignment opportunities are determined based on:
transmission characteristics of a set of global navigation satellite system (GNSS) space vehicles in view of the wireless communications device at a current location of the wireless communications device, and
orbit information of the one or more NTN space vehicles.

22. The method of claim 21, wherein the transmission characteristics comprise an estimated transmit power, path loss, and antenna gain of the set of GNSS space vehicles.

23. The method of claim 22, wherein the antenna gain is determined based on:
multiple measurements of the set of GNSS space vehicles,
an empirical model of the antenna gain,
a machine learning model of the antenna gain, or
any combination thereof.

24. The method of claim 20, further comprising:
determining that the one or more alignment opportunities will not occur within a threshold period of time of a current time; and
prompting a user of the wireless communications device to reposition the wireless communications device.

25. The method of claim 20, further comprising:
transitioning to a sleep state until the at least one alignment opportunity of the one or more alignment opportunities.

26. The method of claim 20, further comprising:
notifying a user of the wireless communications device of a time of a next alignment opportunity of the one or more alignment opportunities.

27. The method of claim 20, wherein detecting the trigger comprises:
receiving a request from a user or another component of the wireless communications device to communicate via NTN connectivity;
detecting an emergency event at the wireless communications device;
determining that the user is incapable of performing an interactive pointing procedure with the wireless communications device; or
any combination thereof.

28. A wireless communications device, comprising:
one or more memories;
one or more transceivers; and
one or more processors communicatively coupled to the one or more memories and the one or more transceivers, the one or more processors, either alone or in combination, configured to:
detect a trigger to communicate via non-terrestrial network (NTN) connectivity;
determine whether one or more obstructions are estimated to be blocking a subset of NTN space vehicles of a set of NTN space vehicles expected to be in view of the wireless communications device at a current location of the wireless communications device; and
transmit, via the one or more transceivers, in response to a determination that the one or more obstructions are estimated to be blocking the subset of NTN space vehicles, at least one message towards at least one NTN space vehicle of the set of NTN space vehicles other than the subset of NTN space vehicles.

29. The wireless communications device of claim 28, wherein the one or more processors configured to determine whether the one or more obstructions are estimated to be blocking the subset of NTN space vehicles comprises the one or more processors, either alone or in combination, configured to:
identify the one or more obstructions on a map of a geographic area in which the wireless communications device is located; and
determine whether the one or more obstructions are within a threshold distance of the current location of the wireless communications device.

30. A wireless communications device, comprising:
one or more memories;
one or more transceivers; and
one or more processors communicatively coupled to the one or more memories and the one or more transceivers, the one or more processors, either alone or in combination, configured to:
detect a trigger to communicate via non-terrestrial network (NTN) connectivity;
determine one or more alignment opportunities associated with one or more NTN space vehicles, wherein each alignment opportunity of the one or more alignment opportunities is a time period during which a main lobe of at least one antenna of the wireless communications device is predicted to be aligned with a line-of-sight (LOS) direction to at least one of the one or more NTN space vehicles; and
transmit, via the one or more transceivers, at least one message towards at least one NTN space vehicle of the one or more NTN space vehicles during at least one alignment opportunity of the one or more alignment opportunities.
